(19) United States
(12) Patent Application Publication
(10) Pub. No.: US 2004/0172505 A1
(43) Pub. Date: Sep. 2, 2004

(54) Bank control circuit, cache memory device and cache memory device designing method

(75) Inventor: Takashi Kurafuji, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/685,579

(22) Filed: Oct. 16, 2003

(30) Foreign Application Priority Data
Feb. 27, 2003 (JP) 2003-050555

(51) Int. Cl. G06F 12/08

(52) U.S. Cl. 711/118; 711/171

(57) ABSTRACT

It is an object to provide a technique capable of reducing a change in a design which is required for varying a cache capacity. A plurality of cache memories (6) are connected to a bank control circuit (7). The bank control circuit (7) selects at least one of the cache memories (6) based on a signal (CSIZE) indicative of a cache capacity and permits to the selected cache memory (6) to be accessed by a bus control circuit (3). Accordingly, it is possible to vary the cache capacity by changing a value of the signal (CSIZE).

### BACKGROUND OF THE INVENTION

1. Field of the Invention

The present invention relates to a cache memory device provided to shorten an access time.

2. Description of the Background Art

A large number of microprocessors include a cache memory device which can give access at a higher speed than a main memory in order to increase the speed of access to data. In general, a cache memory device comprises a cache memory for storing copy data of the main memory and a peripheral circuit for executing a decision whether the cache memory stores the copy data.

A cache address indicative of an address of the main memory is input to the cache memory device and the peripheral circuit of the cache memory device is operated by using a tag or an index which is included in the cache address. Moreover, the cache memory of the cache memory device is accessed setting the index in the cache address as an address. An example of a structure of the cache memory device has been disclosed in Japanese Patent Application Laid-Open No. 5-28045 (1993) (which will be hereinafter referred to as Patent Document 1).

In a conventional cache memory device, in the case in which a memory capacity of a cache memory is to be changed to vary a cache capacity, it is necessary to change a bit number of an index to be an address of the cache memory. For this reason, the bit number of a tag is also changed. More specifically, it is necessary to increase the bit number of the index when the cache capacity is to be increased, and it is necessary to decrease the bit number when the cache capacity is to be decreased.

In the case in which the cache capacity is to be varied, accordingly, it is necessary to redesign a peripheral circuit which is operated by using a tag or an index.

### SUMMARY OF THE INVENTION

It is an object of the present invention to provide a technique capable of reducing a change in a design which is required for varying a cache capacity.

According to the present invention, a cache memory device includes at least one cache memory storing copy data of a main memory, and a bank control circuit which is connected to the at least one cache memory and is capable of generating a plurality of control signals for access. The bank control circuit receives a signal indicative of cache capacity and permits at least one control signal selected out of the plurality of control signals to access the at least one cache memory, respectively, in accordance with the signal.

The bank control circuit permits the control signal selected out of the plurality of the control signals to access the cache memory in accordance with the signal indicative of the cache capacity. By varying the capacity indicated by the signal, therefore, it is possible to easily implement plural kinds of cache capacities. Accordingly, it is possible to reduce a change in the design required for varying the cache capacity.

According to the present invention, a first method of designing a cache memory device serves to design a cache memory device including at least one cache memory for storing copy data of a main memory and the method includes the steps of (a) to (c). The step (a) is to design a bank control circuit connectable to a first predetermined number of plural cache memories and capable of permitting one or more cache memories of the first predetermined number of plural cache memories to be accessed, and to change the number of one or more cache memories to be permitted to be accessed. The step (b) is to design a first cache memory device including the bank control circuit designed in the step (a). The step (c) is to design a second cache memory device including the bank control circuit designed in the step (a). The step (b) includes the step (b-1). The step (b-1) is to design a second predetermined number of cache memories which is equal to or smaller than the first predetermined number. Moreover, the step (c) includes the step (c-1). The step (c-1) is to design a third predetermined number of cache memories which is equal to or smaller than the first predetermined number and is different from the second predetermined number.

The first and second cache memory devices include the bank control circuit designed in the step (a). Therefore, it is not necessary to separately design the bank control circuit when designing the first and second cache memory devices. Accordingly, it is possible to reduce a change in the design required for varying the cache memory capacity.

According to the present invention, a second method of designing a cache memory device serves to design a cache memory device including at least one cache memory for storing copy data of a main memory, and includes the steps (a) and (b). The step (a) is to design a first cache memory device. The step (b) is to design a second cache memory device after the step (a). The step (a) includes the step (a-1). The step (a-1) is to design a bank control circuit connectable to a first predetermined number of plural cache memories and capable of permitting one or more cache memories of the first predetermined number of plural cache memories to be accessed, and to change the number of one or more cache memories to be permitting to be accessed. Moreover, the step (b) includes the steps (b-1) and (b-2). The step (b-1) is to design a second predetermined number of cache memories. The step (b-2) is to redesign the bank control circuit designed in the step (a) in such a manner that the second predetermined number of cache memories are connected when the second predetermined number is greater than the first predetermined number.

In the case in which the number of the cache memories is greater than the number of the cache memories connectable to the bank control circuit, the bank control circuit is redesigned. Therefore, it is not necessary to redesign other peripheral circuits. Accordingly, it is possible to reduce a change in the design required for varying the cache capacity.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of a microprocessor according to a first embodiment of the present invention,

FIG. 2 is a diagram showing a connecting relationship between a bus control circuit and a cache peripheral circuit according to the first embodiment of the present invention,

FIG. 3 is a diagram showing a connecting relationship between a bank control circuit and a cache memory according to the first embodiment of the present invention,

FIG. 4 is a diagram showing a structure of a cache address,

FIG. 5 is a block diagram showing a structure of the bank control circuit according to the first embodiment of the present invention,

FIG. 6 is a diagram showing a relationship among a signal CSIZE, a signal BID and a bank n selection signal,

FIG. 7 is a block diagram showing a structure of the cache memory according to the first embodiment of the present invention,

FIG. 8 is a block diagram showing a structure of the cache peripheral circuit according to the first embodiment of the present invention,

FIGS. 9 to 21 are timing charts showing an operation of the microprocessor according to the first embodiment of the present invention,

FIGS. 22 to 26 are block diagrams showing a structure of the microprocessor according to the first embodiment of the present invention,

FIGS. 27 and 28 are block diagrams showing the structure of the bank control circuit according to the first embodiment of the present invention,

FIGS. 29 and 30 are diagrams showing the relationship among the signal CSIZE, the signal BID and the bank n selection signal,

FIG. 31 is a block diagram showing the structure of the microprocessor according to the first embodiment of the present invention,

FIG. 32 is a block diagram showing a structure of a power control circuit according to the first embodiment of the present invention,

FIG. 33 is a flowchart showing a method of designing a cache memory device according to a second embodiment of the present invention,

FIGS. 34 to 37 are flowcharts showing a method of designing a cache memory device according to a third embodiment of the present invention,

FIG. 38 is a block diagram showing a structure of a variant of the microprocessor according to the first embodiment of the present invention, and

FIG. 39 is a flowchart showing a method of designing a microprocessor according to a fourth embodiment of the present invention.

### DESCRIPTION OF THE PREFERRED EMBODIMENTS

First Embodiment

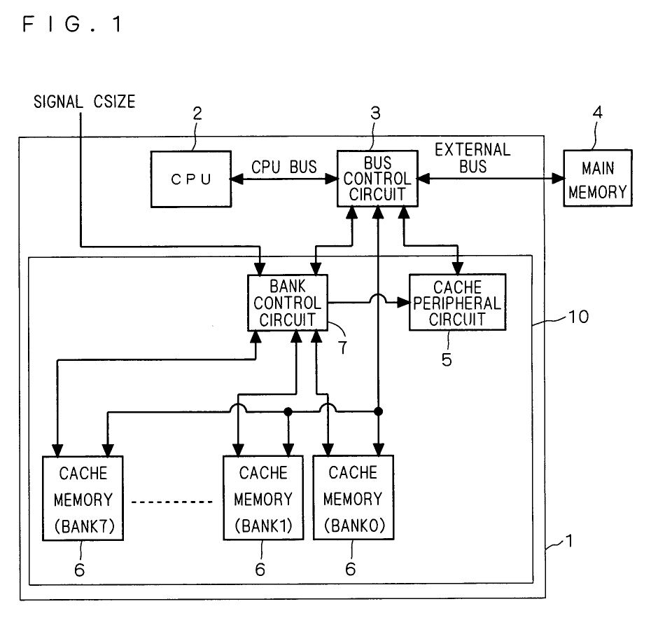

FIG. 1 is a block diagram showing a structure of a microprocessor 1 according to a first embodiment of the present invention. As shown in FIG. 1, the microprocessor 1 according to the first embodiment comprises a CPU 2 for executing an instruction in accordance with a program, a cache memory device 10 and a bus control circuit 3.

The CPU 2 gives access to the cache memory device 10 and a main memory 4 provided on the outside of the microprocessor 1 through the bus control circuit 3. The bus control circuit 3 actually executes access to the cache memory device 10 and the main memory 4 in accordance with an instruction of the CPU 2.

The CPU 2 and the bus control circuit 3 are connected to each other through a CPU bus and transfers a signal through the CPU bus. Moreover, the bus control circuit 3 and the external main memory 4 are connected to each other through an external bus and transfers a signal through the external bus.

The cache memory device 10 comprises a plurality of cache memories 6 for storing copy data of the main memory 4, a cache peripheral circuit 5, and a bank control circuit 7 for controlling access to be given from the bus control circuit 3 to the cache memory 6.

The cache memory device 10 according to the first embodiment is provided with eight cache memories 6, for example. Each of the cache memories 6 has a memory capacity of 2 K bytes for storing the copy data of the main memory 4. In other words, the cache memory device 10 has a memory capacity of 16 K bytes which can be used as a cache capacity. Subsequently, each of the eight cache memories 6 will be hereinafter referred to as the cache memory 6 of a bank 0, the cache memory 6 of a bank 1, . . . the cache memory 6 of a bank 7.

The bank control circuit 7 is connectable to a plurality of cache memories 6 and selects at least one from the connected cache memories 6 based on a signal CSIZE input from the outside of the microprocessor 1. Then, the bank control circuit 7 permits the cache memory 6 thus selected to be accessed by the bus control circuit 3. Consequently, the sum of the capacities of the cache memories 6 selected by the bank control circuit 7 is set to be a cache capacity of the cache memory device 10. For example, the cache capacity of the cache memory device 10 has 2 K bytes when the bank control circuit 7 selects only the cache memory 6 of the bank 0, and has 4 K bytes when the bank control circuit 7 selects the cache memories 6 of the banks 0 and 1.

The bank control circuit 7 according to the first embodiment is connectable to the eight cache memories 6, for example. In other words, the same number of cache memories 6 as the total number of connectable cache memories 6 are connected to the bank control circuit 7.

In the cache memory device 10 according to the first embodiment, an LRU (Least Recently Used) method is employed for data replacement and a 2-way set associative method having a block length of 4 bytes is employed for a structure. Moreover, a copy back method is employed for a writing method to the main memory 4.

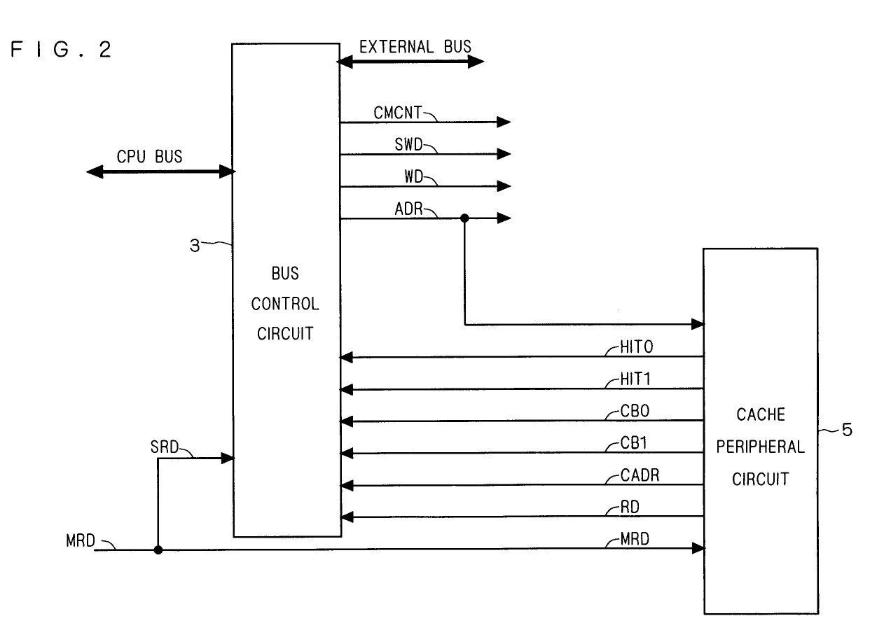

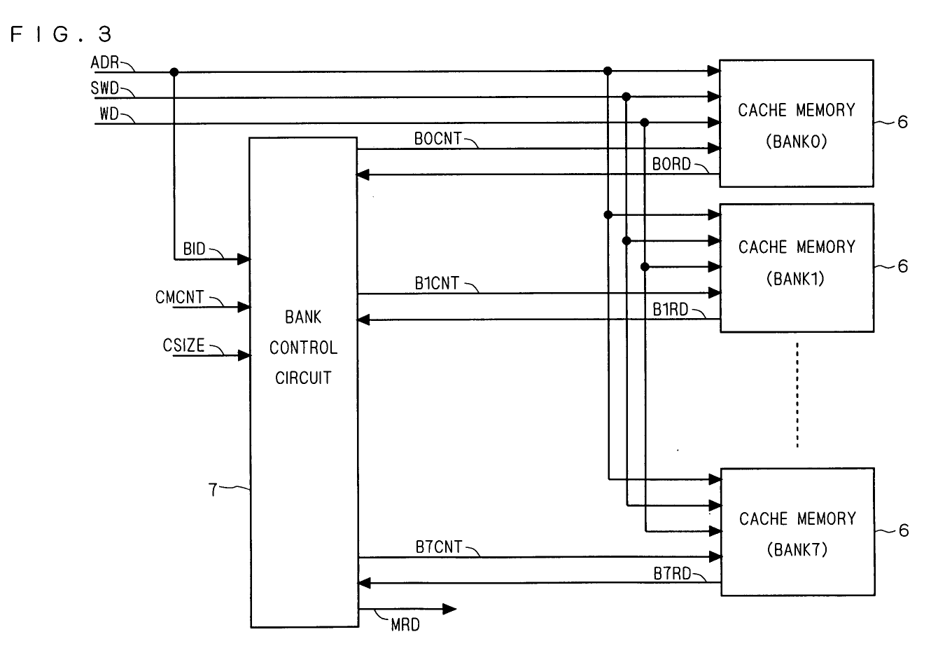

Next, a connecting relationship between components included in the microprocessor 1 will be described in detail. FIG. 2 shows a connecting relationship between the bus control circuit 3 and the cache peripheral circuit 5 and FIG. 3 shows a connecting relationship between the bank control circuit 7 and the cache memory 6.

As shown in FIG. 2, the bus control circuit 3 outputs a cache memory control signal CMCNT required for giving access to the cache memory 6, a cache address ADR indicative of an address of the main memory 4, status write data SWD and write data WD in response to a request of the CPU 2.

The cache memory control signal CMCNT includes a status access request signal SREQ, a status write control signal SWCNT, a way0 tag access request signal TREQ0, a way0 tag write control signal TCNT0, a way1 tag access request signal TREQ1, a way1 tag write control signal TCNT1, a way0 data access request signal DREQ0, a way0 data write control signal DCNT0, a way1 data access request signal DREQ1 and a way1 data write control signal DCNT1. Moreover, status read data SRD is input to the bus control circuit 3. The status read data SRD is included in memory read data MRD output from the bank control circuit 7.

As shown in FIG. 2, the memory read data MRD and the cache address ADR are input to the cache peripheral circuit 5. Based on them, the cache peripheral circuit 5 outputs a way0 hit signal HIT0, a way1 hit signal HIT1, a way0 copy back signal CB0, a way1 copy back signal CB1, a copy back address CADR and read data RD to the bus control circuit 3.

The cache address ADR, the status write data SWD and the write data WD are input to each cache memory 6 as shown in FIG. 3. Moreover, the cache memory 6 of a bank n (n=0 to 7) outputs bank n read data BnRD to the bank control circuit 7. The bank n read data BnRD include bank n status read data BnSRD, bank n way0 read data Bnw0RD, bank n way1 read data Bnw1RD, bank n way0 tag read data Bnw0TRD and bank n way1 tag read data Bnw1TRD.

A signal BID to be a part of the cache address ADR, the cache memory control signal CMCNT, and the signal CSIZE sent from the outside of the microprocessor 1 are input to the bank control circuit 7 as shown in FIG. 3. Based on these signals, the bank control circuit 7 outputs bank n control signal BnCNT (n=0 to 7) to the cache memory 6 of the bank n. Moreover, the bank control circuit 7 outputs the memory read data MRD based on the bank n read data BnRD output from each cache memory 6, the signal CSIZE and the signal BID.

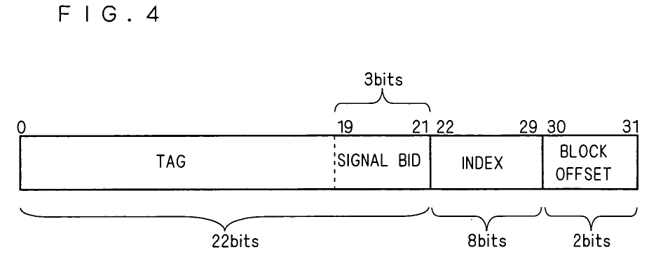

FIG. 4 is a diagram showing a structure of the cache address ADR output from the bus control circuit 3. As shown in FIG. 4, the cache address ADR is constituted by 32 bits. The cache address ADR includes a 22-bit tag TG, an 8-bit index ID and a 2-bit block offset BO.

In the cache address ADR, bit positions occupied by the tag TG, the index ID and the block offset BO are fixed, the tag TG occupies 0th to 21st bits of the cache address ADR, the index ID occupies 22nd to 29th bits and the block offset BO occupies 30th and 31st bits. The signal BID input to the bank control circuit 7 is a part of the tag TG and a 3-bit signal occupying 19th to 21st bits of the cache address ADR. In the cache address ADR according to the first embodiment, a 0th bit is a most significant bit and a 31st bit is a least significant bit.

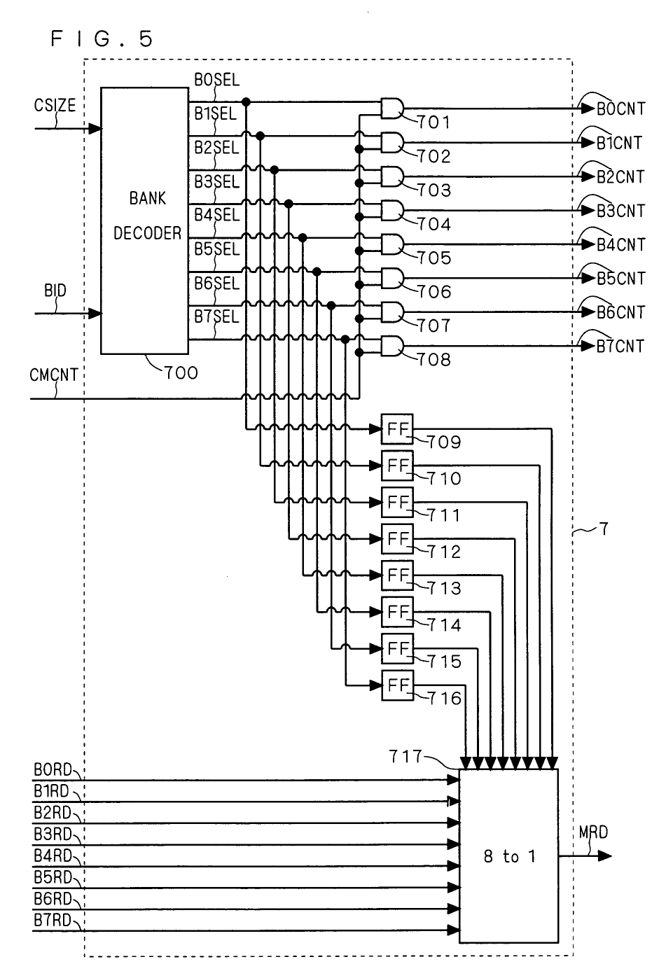

Next, structures of the bank control circuit 7, the cache memory 6 and the cache peripheral circuit 5 will be described in detail. FIGS. 5, 7 and 8 show their structures, respectively.

As shown in FIG. 5, the bank control circuit 7 comprises a bank decoder 700, AND circuits 701 to 708, flip-flops 709 to 716 and a selector 717.

The bank decoder 700 outputs a bank 0 selection signal B0SEL to a bank 7 selection signal B7SEL based on the signals CSIZE and BID. The signal CSIZE indicates a cache capacity and is constituted by 2 bits. For example, the signal CSIZE indicates 2 K bytes with “00”, 4 K bytes with “01”, 8 K bytes with “10” and 16 K bytes with “11”. The bank control circuit 7 selects the cache memory 6 in such a manner that the cache memory device 10 has a cache capacity indicated by the signal CSIZE. For example, in the case in which the signal CSIZE indicates “10”, the bank control circuit 7 selects the cache memories 6 of the banks 0 to 3. In some cases, the signal CSIZE is supplied from an external device provided on the outside of the microprocessor 1 or is supplied by fixing an electric potential of an input terminal for the signal CSIZE in the microprocessor 1.

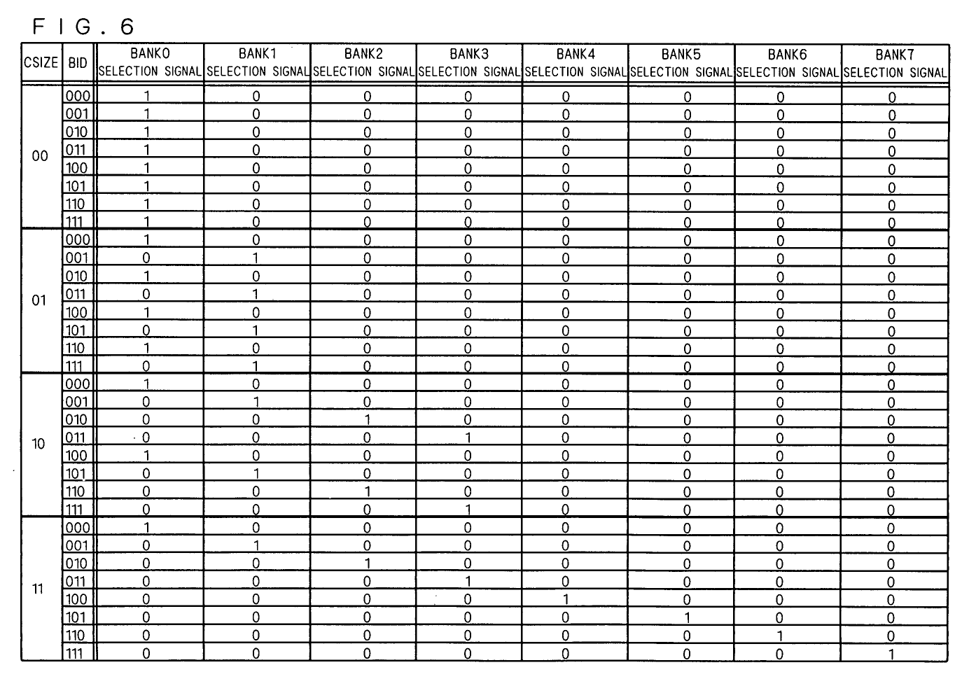

FIG. 6 is a diagram showing a relationship among the signal CSIZE, the signal BID and the bank n selection signal BnSEL. As shown in FIG. 6, when the signal CSIZE is “00”, only the bank 0 selection signal B0SEL is always “1” and the bank 1 selection signal B1SEL to the bank 7 selection signal B7SEL are always “0” irrespective of a value of the signal BID. In the case in which the signal CSIZE is “01”, only the bank 0 selection signal B0SEL is “1” when a least significant bit of the signal BID is “0” and only the bank 1 selection signal B1SEL is “1” when the least significant bit of the signal BID is “1”.

In the case in which the signal CSIZE is “10”, moreover, only the bank 0 selection signal B0SEL is “1” when 2 lower bits of the signal BID is “00”, only the bank 1 selection signal B1SEL is “1” when the 2 lower bits of the signal BID is “01”, only the bank 2 selection signal B2SEL is “1” when the 2 lower bits of the signal BID is “10”, and only the bank 3 selection signal B3SEL is “1” when the 2 lower bits of the signal BID is “11”. In the case in which the signal CSIZE is “11”, only the bank 0 selection signal B0SEL is “1” when the signal BID is “000”, only the bank 1 selection signal B1SEL is “1” when the signal BID is “001”, only the bank 2 selection signal B2SEL is “1” when the signal BID is “010”, only the bank 3 selection signal B3SEL is “1” when the signal BID is “011”, only the bank 4 selection signal B4SEL is “1” when the signal BID is “100”, only the bank 5 selection signal B5SEL is “1” when the signal BID is “101”, only the bank 6 selection signal B6SEL is “1” when the signal BID is “110”, and only the bank 7 selection signal B7SEL is “1” when the signal BID is “111”.

The AND circuits 701 to 708 calculate logical products of the bank 0 selection signal B0SEL to the bank 7 selection signal B7SEL and the cache memory control signal CMCNT respectively, and output them as a bank 0 control signal B0CNT to a bank 7 control signal B7CNT respectively.

The status access request signal SREQ, the status write control signal SWCNT, the way0 tag access request signal TREQ0, the way0 tag write control signal TCNT0, the way1 tag access request signal TREQ1, the way1 tag write control signal TCNT1, the way0 data access request signal DREQ0, the way0 data write control signal DCNT0, the way1 data access request signal DREQ1 and the way1 data write control signal DCNT1 which are included in a bank n control signal BnCNT (n=0 to 7) will be referred to as a bank n status access request signal BnSREQ, a bank n status write control signal BnSWCNT, a bank n way0 Bn tag access request signal TREQ0, a bank n way0 tag write control signal BnTCNT0, a bank n way1 tag access request signal BnTREQ1, a bank n way1 tag write control signal BnTCNT1, a bank n way0 data access request signal BNDREQ0, a bank n way0 data write control signal BnDCNT0, a bank n way1 data access request signal BnDREQ1 and a bank n way1 data write control signal BnDCNT1, respectively.

The bank 0 selection signal B0SEL to the bank 7 selection signal B7SEL are input to the flip-flops 709 to 716, respectively. A clock signal CLK which is not shown is also input to the flip-flops 709 to 716. The flip-flops 709 to 716 delay the input signals for the time corresponding to one clock cycle of the clock signal CLK and output the results. The clock signal CLK is also input to the CPU 2 and the CPU 2 is operated by setting the clock signal CLK to be a CPU clock.

The bank 0 read data B0RD to the bank 7 read data B7RD and outputs of the flip-flops 709 to 716 are input to the selector 717. Based on the outputs of the flip-flops 709 to 716, then, the selector 717 selects one of the bank 0 read data B0RD to the bank 7 read data B7RD and outputs it as the memory read data MRD.

More specifically, the selector 717 outputs the bank 0 read data B0RD when the output of the flip-flop 709 is exclusively “1”, outputs the bank 1 read data BIRD when the output of the flip-flop 710 is exclusively “1”, outputs the bank 2 read data B2RD when the output of the flip-flop 711 is exclusively “1”, and outputs the bank 3 read data B3RD when the output of the flip-flop 712 is exclusively “I”. Moreover, the selector 717 outputs the bank 4 read data B4RD when the output of the flip-flop 713 is exclusively “1”, outputs the bank 5 read data B5RD when the output of the flip-flop 714 is exclusively “1”, outputs the bank 6 read data B6RD when the output of the flip-flop 715 is exclusively “1”, and outputs the bank 7 read data B7RD when the output of the flip-flop 716 is exclusively “1”.

In the case in which all the outputs of the flip-flops 709 to 716 are “0” or at least two outputs are “1”, the output of the selector 717 is undefined.

Thus, the bank control circuit 7 selects the cache memory 6 based on the signal CSIZE and permits access to the cache memory 6 thus selected. For example, when the signal CSIZE is “01” and indicates 4 K bytes, the bank control circuit 7 selects the cache memories 6 of the banks 0 and 1 and outputs the cache memory control signal CMCNT to the cache memories 6 of the banks 0 and 1 as shown in FIG. 6. Consequently, access is permitted to be given from the bus control circuit 3 to the cache memories 6 of the banks 0 and 1 thus selected, and the cache memory device 10 has a cache capacity of 4 K bytes.

The bank control circuit 7 outputs the cache memory control signal CMCNT to the cache memory 6 of the bank 0 or 1 depending on the value of the signal BID, thereby switching the cache memory 6 of an output destination for the cache memory control signal CMCNT. Consequently, one of the cache memories 6 is accessed through one accessing operation of the bus control circuit 3.

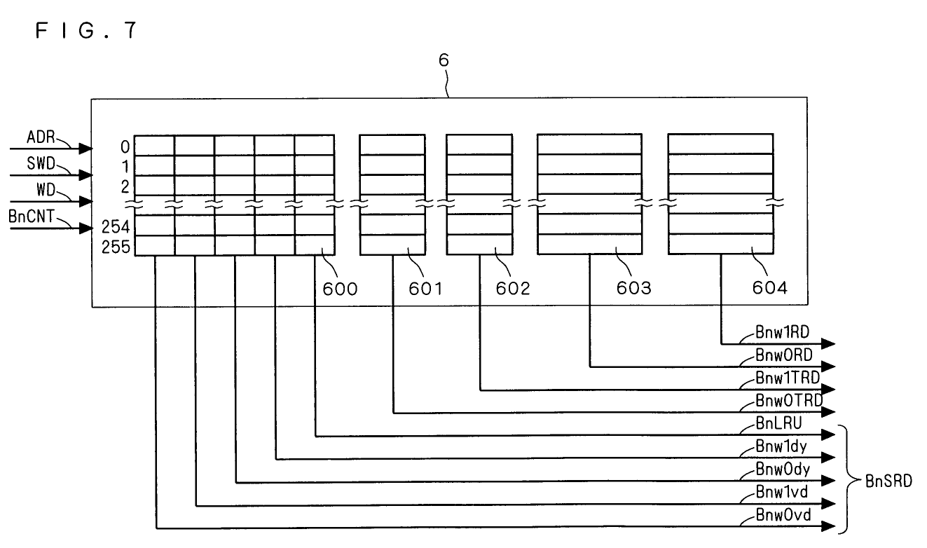

As shown in FIG. 7, the cache memory 6 of the bank n comprises a status memory 600 for storing data indicative of a state of the cache memory 6, a way0 tag memory 601 and a way1 tag memory 602 which serve to store a tag TG in the cache address ADR, and a way0 data memory 603 and a way1 data memory 604 which serve to store the copy data of the main memory 4. An index ID in the cache address ADR is an address for access to each of the memories 600 to 604. In other words, each memory has 256 memory areas indicated by 8 bits and a memory area indicated by the index ID is accessed. In some cases, the way0 tag memory 601 and the way1 tag memory 602 will be referred to as a “tag memory 612” together and the way0 data memory 603 and the way1 data memory 604 will be referred to as a “data memory 634” together.

The status memory 600 is access controlled in response to the bank n status access request signal BnSREQ and the bank n status write control signal BnSWCNT. More specifically, access is permitted to be given to the status memory 600 when the bank n status access request signal BnSREQ has a High level, write access is given when the bank n status write control signal BnSWCNT has the High level, and read access is given when the bank n status write control signal BnSWCNT has a Low level.

The status write data SWD are written to the status memory 600, and the data read from the status memory 600 are output as the bank n status read data BnSRD. The bank n status read data BnSRD are constituted by bank n data Bnw0vd, Bnw1vd, Bnw0dy, Bnw1dy and BnLRU (n=0 to 7).

The status memory 600 has a data width of 5 bits, and 5-bit information stored in each address will be referred to as a way0_valid bit, a way1_valid bit, a way0_dirty bit, a way1_dirty bit and an LRU bit, respectively. These bits will be collectively referred to as a “cache status”.

The way0_valid bit in each address indicates whether data stored in the way0 tag memory 601 and the way0 data memory 603 in the same address as that address are valid or not, and “1” indicates “valid”. Moreover, the way1_valid bit in each address indicates whether data stored in the way1 tag memory 602 and the way1 data memory 604 in the same address as that address are valid or not, and “1” indicates “valid”. 1-bit data indicated by the way0_valid bit are output as the bank n data Bnw0vd and 1-bit data indicated by the way1_valid bit are output as the bank n data Bnw1vd.

The way0_dirty bit in each address indicates whether the data stored in the way0 data memory 603 in the same address as that address are different from the data of the main memory 4 or not, and “1” indicates that they are different from each other. In other words, the way0_dirty bit indicates whether the data stored in the way0 data memory 603 are the copy data of the main memory 4 or not, and “1” indicates that the same data are not the copy data. Moreover, the way1_dirty bit in each address indicates whether the data stored in the way1 data memory 604 in the same address as that address are different from the data of the main memory 4 or not, and “1” indicates that they are different from each other. 1-bit data indicated by the way0_dirty bit are output as the bank n data Bnw0dy and 1-bit data indicated by the way1_dirty bit are output as the bank n data Bnw1dy.

The LRU bit in each address indicates either of memory areas of the way0 data memory 603 and the way1 data memory 604 in the same address as that address which is accessed more recently, and indicates that the way0 data memory 603 is accessed more recently if the LRU bit is “0” and that the way1 data memory 604 is accessed more recently if the LRU bit is “1”. 1-bit data indicated by the LRU bit are output as the bank n data BnLRU.

The way0 tag memory 601 is access controlled in response to the bank n way0 tag access request signal BnTREQ0 and the bank n way0 tag write control signal BnTCNT0. More specifically, access is permitted to be given to the way0 tag memory 601 when the bank n way0 tag access request signal BnTREQ0 has a High level, write access is given when the bank n way0 tag write control signal BnTCNT0 has the High level, and read access is given when the bank n way0 tag write control signal BnTCNT0 has a Low level.

The tag TG in the cache address ADR is written to the way0 tag memory 601. The data read from the way0 tag memory 601 are output as the bank n way0 tag read data Bnw0TRD.

The way1 tag memory 602 is access controlled in response to the bank n way1 tag access request signal BnTREQ1 and the bank n way1 tag write control signal BnTCNT1. More specifically, access is permitted to be given to the way1 tag memory 602 when the bank n way1 tag access request signal BnTREQ1 has a High level, write access is given when the bank n way1 tag write control signal BnTCNT1 has the High level, and read access is given when the bank n way1 tag write control signal BnTCNT1 has a Low level.

The tag TG in the cache address ADR is written to the way1 tag memory 602. The data read from the way1 tag memory 602 are output as the bank n way1 tag read data Bnw1TRD.

The way0 tag memory 601 and the way1 tag memory 602 have a data width of 22 bits which is equal to a bit number of the tag TG.

The way0 data memory 603 is access controlled in response to the bank n way0 data access request signal BnDREQ0 and the bank n way0 data write control signal BnDCNT0. More specifically, access is permitted to be given to the n way0 data memory 603 when the bank n way0 data access request signal BnDREQ0 has a High level, write access is given when the bank n way0 data write control signal BnDCNT0 has the High level, and read access is given when the bank n way0 data write control signal BnDCNT0 has a Low level.

The write data WD are written to the way0 data memory 603. The data read from the way0 data memory 603 are output as the bank n way0 read data Bnw0RD.

The way1 data memory 604 is access controlled in response to the bank n way1 data access request signal BnDREQ1 and the bank n way1 data write control signal BnDCNT1. More specifically, access is permitted to be given to the way1 data memory 603 when the bank n way1 data access request signal BnDREQ1 has a High level, write access is given when the bank n way1 data write control signal BnDCNT1 has the High level, and read access is given when the bank n way1 data write control signal BnDCNT1 has a Low level.

The write data WD are also written to the way1 data memory 604. The data read from the way1 data memory 604 are output as the bank n way1 read data Bnw1RD.

The way0 data memory 603 and the way1 data memory 604 have a data width of 4 bytes which is equal to a block length. Moreover, the way0 data memory 603 and the way1 data memory 604 have an address width of 8 bits. Therefore, the respective memories have a capacity of 1 K byte (4 bytes X 256). Accordingly, the cache memory 6 of the bank n has a memory capacity of 2 K bytes for storing the copy data of the main memory 4. Since the way0 data memory 603 and the way1 data memory 604 are thus accessed on a 4-byte unit, the block offset BO in the cache address ADR is not particularly used when each memory in the cache memory 6 is to be accessed.

As described above, the bank n status read data BnSRD, the bank n way0 read data Bnw0RD, the bank n way1 read data Bnw1RD, the bank n way0 tag read data Bnw1TRD and the bank n way1 tag read data Bnw1TRD which are read from the cache memory 6 of the bank n are input as the bank n read data BnRD to the bank control circuit 7.

Then, the bank n status read data BnSRD, the bank n way0 read data Bnw0RD, the bank n way1 read data Bnw1RD, the bank n way0 tag read data Bnw1TRD and the bank n way1 tag read data Bnw1TRD which are included in the bank n read data BnRD and selected by the selector 717 of the bank control circuit 7 are output, from the bank control circuit 7, as the status read data SRD, the way0 read data w0RD, the way1 read data w1RD, the way0 tag read data w1TRD and the way1 tag read data w1TRD respectively. In other words, the memory read data MRD include the status read data SRD, the way0 read data w0RD, the way1 read data w1RD, the way0 tag read data w0TRD and the way1 tag read data w1TRD.

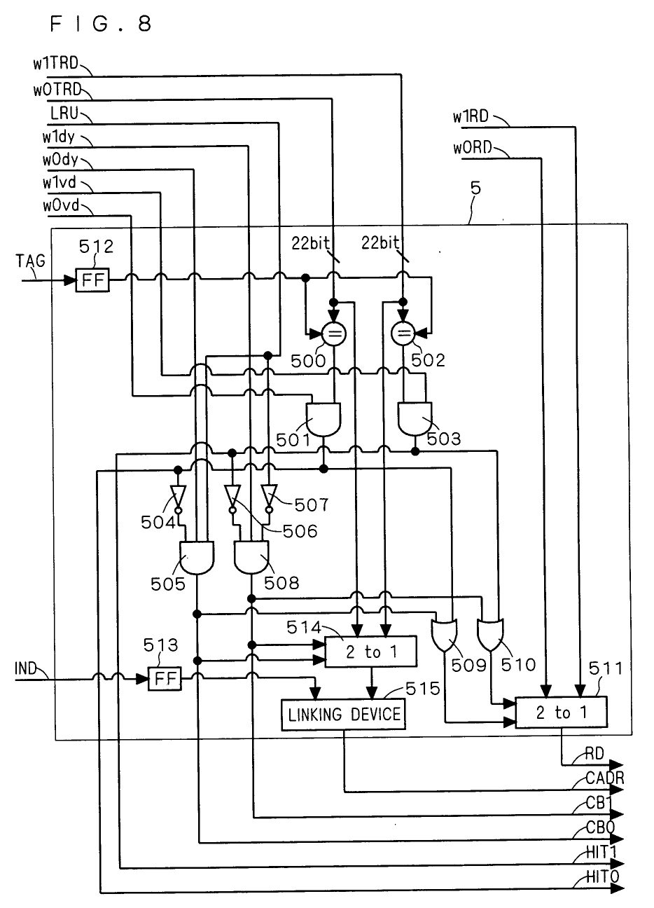

As shown in FIG. 8, the cache peripheral circuit 5 comprises comparators 500 and 502, AND circuits 501, 503, 505 and 508, inverters 504, 506 and 507, OR circuits 509 and 510, selectors 511 and 514, flip-flops 512 and 513, and a linking device 515.

The flip-flops 512 and 513 delay the tag TG and the index ID in the cache address ADR for the time corresponding to one clock of the clock signal CLK and output them respectively.

The comparator 500 compares the way0 tag read data w0TRD included in the memory read data MRD to an output of the flip-flop 512, and outputs “1” when detecting their coincidence and outputs “0” when detecting their non-coincidence. Moreover, the comparator 502 compares the way1 tag read data w1TRD included in the memory read data MRD to the output of the flip-flop 512, and outputs “1” when detecting their coincidence and outputs “0” when detecting their non-coincidence.

The AND circuit 501 calculates a logical product of an output of the comparator 500 and the data w0vd and outputs the logical product as the way0 hit signal HIT0. Moreover, the AND circuit 503 calculates a logical product of an output of the comparator 502 and the data w1vd and outputs the logical product as the way1 hit signal HIT1.

The AND circuit 505 calculates a logical product of the output of the AND circuit 501 which is inverted by the inverter 504, the data w0dy and the data LRU and outputs the logical product as the way0 copy back signal CB0. Moreover, the AND circuit 508 calculates a logical product of the output of the AND circuit 503 which is inverted by the inverter 506, the data w1dy and the data LRU inverted by the inverter 507, and outputs the logical product as the way1 copy back signal CB1.

The OR circuit 509 calculates and outputs a logical sum of the outputs of the AND circuits 501 and 505, and the OR circuit 510 calculates and outputs a logical sum of the outputs of the AND circuits 503 and 508.

The selector 511 selects and outputs either the way0 read data w0RD or the way1 read data w1RD as the read data RD based on the outputs of the OR circuits 509 and 510. When the output of the OR circuit 509 is “1” and the output of the OR circuit 510 is “0”, the selector 511 outputs the way0 read data w0RD as the read data RD. When the output of the OR circuit 509 is “0” and the output of the OR circuit 510 is “1”, the selector 511 outputs the way1 read data w1RD as the read data RD. When the outputs of the OR circuits 509 and 510 are identical to each other, the output of the selector 511 is undefined.

The selector 514 selects and outputs either the way0 tag read data w0TRD or the way1 tag read data w1TRD based on the outputs of the AND circuits 505 and 508. When the output of the AND circuit 505 is “1” and the output of the AND circuit 508 is “0”, the selector 514 outputs the way0 tag read data w0TRD. When the output of the AND circuit 505 is “0” and the output of the AND circuit 508 is “1”, the selector 514 outputs the way1 tag read data w1TRD. When the outputs of the AND circuits 505 and 508 are identical to each other, the output of the selector 514 is undefined.

The linking device 515 links the output of the flip-flop 513 to the output of the selector 514 and outputs the linked outputs as the copy back address CADR. The linking device 515 assigns the output of the selector 514 to 0th to 21st bits of the copy back address CADR, and assigns the output of the flip-flop 513 to 22nd to 29th bits of the copy back address CADR. In other words, the copy back address CADR includes the output of the selector 514 in the 0th to 21st bits, and includes, in the 22nd to 29th bits, the index ID in the cache address ADR which is input.

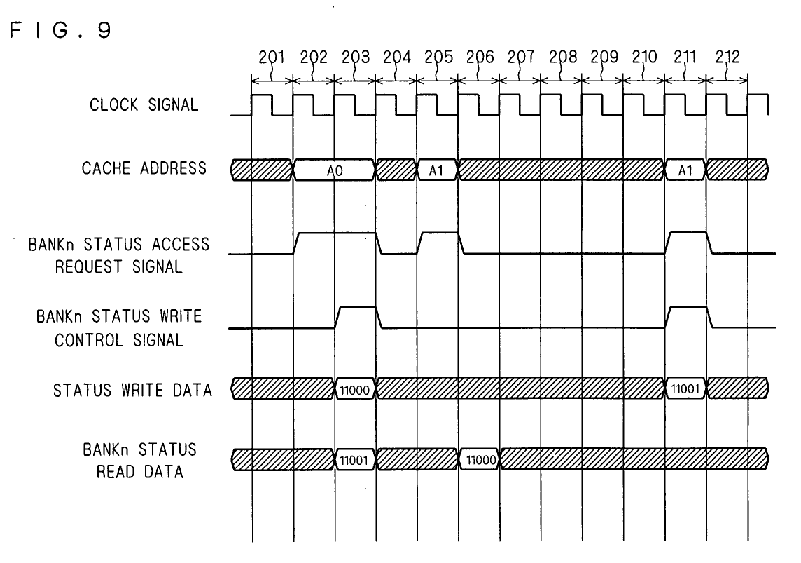

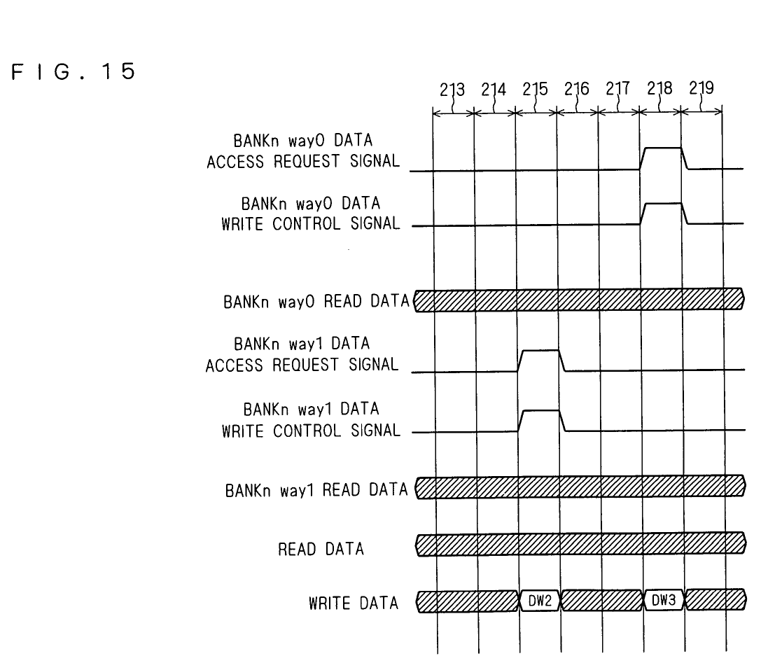

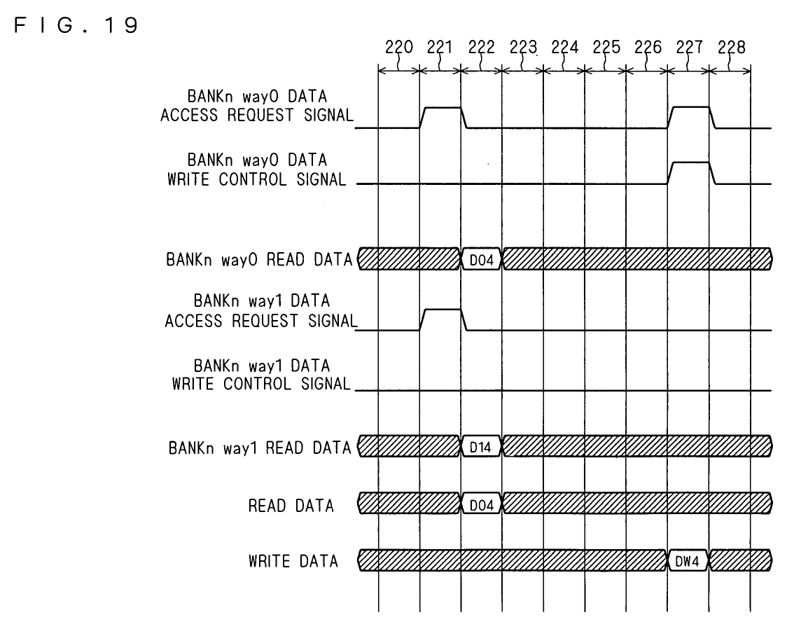

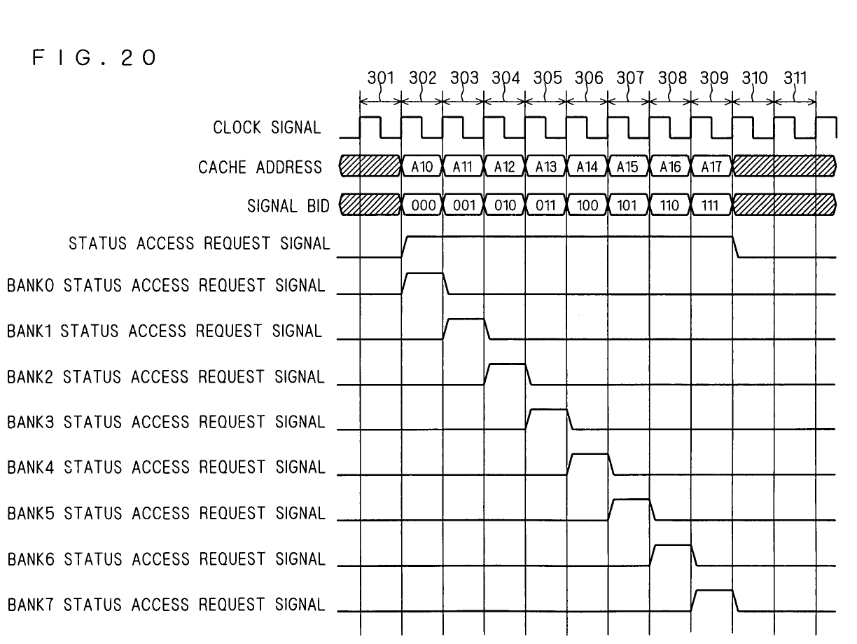

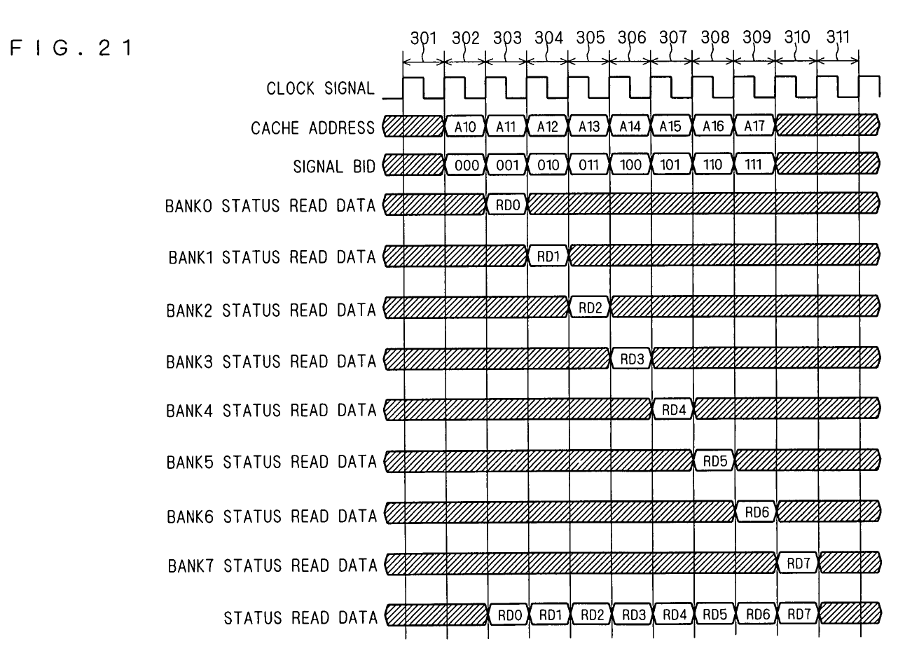

Next, description will be given to a cache operation of the microprocessor 1 according to the first embodiment. FIGS. 9 to 12 are timing charts in a read operation and FIGS. 13 to 15 are timing charts in a write operation. Moreover, FIGS. 16 to 19 are timing charts in execution of copy back and FIGS. 20 and 21 are timing charts in continuous access to the different cache memories 6.

Cycles 201 to 228 and 301 to 311 in the drawings indicate one cycle of the clock signal CLK to be a CPU clock. In the following description of the operation, moreover, data corresponding to the way0_valid bit, way1_valid bit, the way0_dirty bit, the way1_diry bit and the LRU bit are represented in this order in binary numbers of “11001”, for example. In the cycles 201, 204, 212, 213, 216, 219, 220, 228, 301 and 311, moreover, the microprocessor 1 executes an operation other than the cache operation.

First of all, the read operation in the cache operation of the microprocessor 1 will be described with reference to FIGS. 9 to 12.

Based on the signal CSIZE, the bank control circuit 7 selects any of the cache memories 6 which permits access. Consequently, the cache memory device 10 has a cache memory capacity indicated by the signal CSIZE.

The CPU2 gives the bus control circuit 3 a request for giving read access to the cache memory 6 of the cache memory device 10.

The bus control circuit 3 receiving the request of the CPU 2 outputs the cache address ADR having a value of “A0” to the cache memory device 10 and outputs the cache memory control signal CMCNT at the same time in the cycle 202 as shown in FIG. 9.

The bank control circuit 7 outputs the cache memory control signal CMCNT as the bank n control signal BnCNT to the cache memory 6 of the bank n in the selected cache memory 6 based on the signal BID included in the received cache address ADR.

In the cycle 202, read access is executed in each memory included in the cache memory 6 of the bank n.

As shown in FIG. 9, in the cycle 202, the bank n status access request signal BnSREQ indicates “1” and the bank n status write control signal BnSWCNT indicates “0”. In the status memory 600 of the cache memory 6 of the bank n, accordingly, the read access is executed for an address indicated by the index ID in the cache address ADR. As a result, in the cycle 203, data are read from the memory area of the address indicated by the index ID and are input as the bank n status read data BnSRD to the bank control circuit 7. A value of the bank n status read data BnSRD read in the cycle 203 is set to be “11001”.

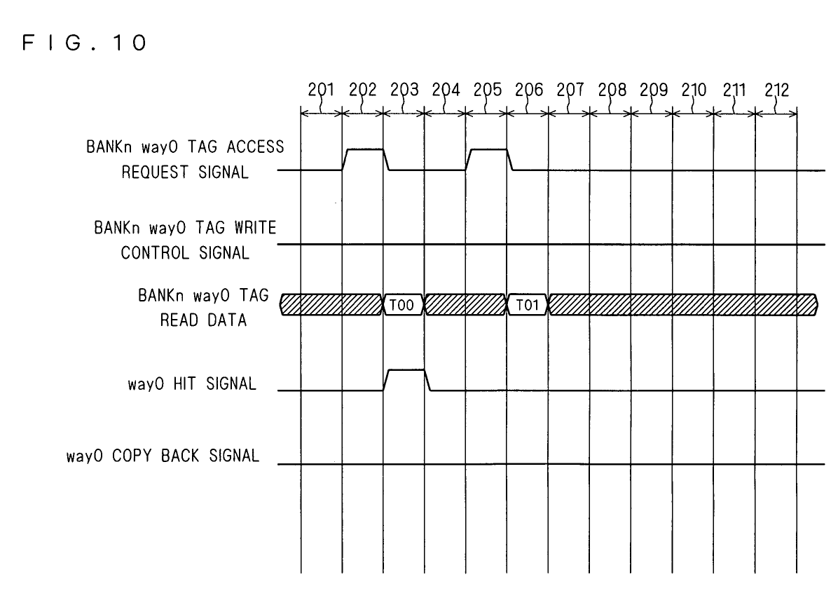

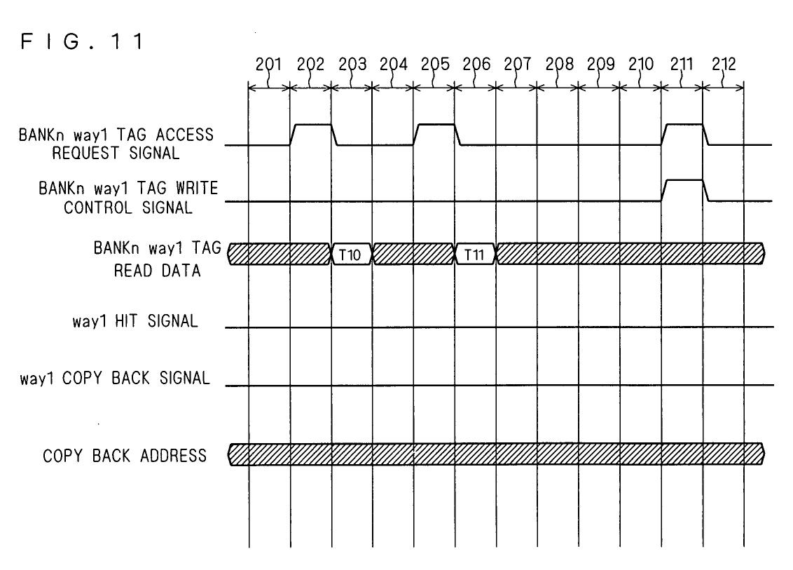

In the cycle 202, moreover, both the bank n way0 tag access request signal BnTREQ0 and the bank n way1 tag access request signal BnTREQ1 indicate “1” and both the bank n way0 tag write control signal BnTCNT0 and the bank n way1 tag write control signal BnTCNT1 indicate “0” as shown in FIGS. 10 and 11. In the tag memory 612 of the cache memory 6 of the bank n, accordingly, the read access is executed for the address indicated by the index ID in the cache address ADR. As a result, in the cycle 203, data are read from the memory area of the address indicated by the index ID and are input as the bank n way0 tag read data Bnw0TRD and the bank n way1 tag read data Bnw1TRD to the bank control circuit 7. Values of the bank n way0 tag read data Bnw0TRD and the bank n way1 tag read data Bnw1TRD read in the cycle 203 are set to be “T00” and “T10”, respectively.

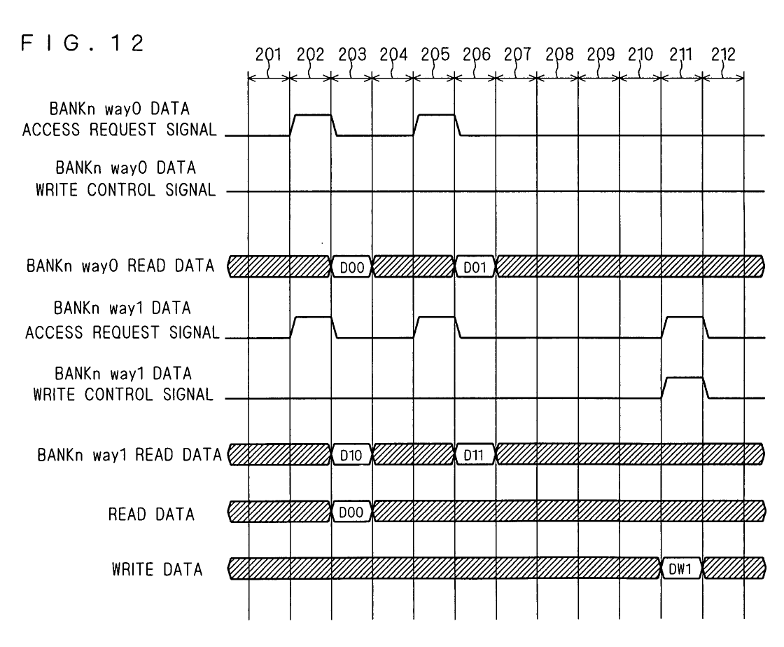

In the cycle 202, moreover, both the bank n way0 data access request signal BNDREQ0 and the bank n way1 data access request signal BnDREQ1 indicate “1” and both the bank n way0 data write control signal BnDCNT0 and the bank n way1 data write control signal BnDCNT1 indicate “0” as shown in FIG. 12. In the data memory 634 of the cache memory 6 of the bank n; accordingly, the read access is executed for the address indicated by the index ID in the cache address ADR. As a result, in the cycle 203, data are read from the memory area of the address indicated by the index ID and are input as the bank n way0 read data Bnw0RD and the bank n way1 read data Bnw1RD to the bank control circuit 7. Values of the bank n way0 read data Bnw0RD and the bank n way1 read data Bnw1RD read in the cycle 203 are set to be “D00” and “D10”, respectively.

In the cycle 203, the bank control circuit 7 outputs the bank n read data BnRD as the memory read data MRD.

In the cycle 203, the flip-flop 512 of the cache peripheral circuit 5 outputs the tag TG in the cache address ADR input in the cycle 202. A value of the tag TG is set to be “T00”.

Since the output value “T00” of the flip-flop 512 is coincident with the value “T00” of the way0 tag read data w0TRD, the comparator 500 outputs “1”. As described above, the value of the bank n status read data BnSRD is “11001”. Therefore, the data w0vd is “1”. Accordingly, “1” is input to both inputs of the AND circuit 501 and the AND circuit 501 outputs “1”. As shown in FIG. 10, consequently, the way0 hit signal HIT0 is “1” in the cycle 203.

Since the output value “T00” of the flip-flop 512 is not coincident with the value “T10” of the way1 tag read data w1TRD, the comparator 502 outputs “0”. Since the output of the comparator 502 is “0”, the AND circuit 503 outputs “0”. As shown in FIG. 11, consequently, the way1 hit signal HIT1 is “0” in the cycle 203.

Since the data w0dy is “0”, the AND circuit 505 outputs “0”. As shown in FIG. 10, consequently, the way0 copy back signal CB0 is “0” in the cycle 203. Since the data w1dy is “0”, moreover, the AND circuit 508 outputs “0”. As shown in FIG. 11, consequently, the way1 copy back signal CB1 is “0” in the cycle 203.

Since the output of the AND circuit 501 is “1”, the OR circuit 509 outputs “1”. Since both of the outputs of the AND circuits 503 and 508 are “0”, the OR circuit 510 outputs “0”. Accordingly, the selector 511 selects the way0 read data w0RD. As shown in FIG. 12, consequently, “D00” is output as the read data RD to the bus control circuit 3 in the cycle 203. Then, the bus control circuit 3 outputs the received read data RD to the CPU 2.

Moreover, write access to the status memory 600 is also executed so that a cache status is updated in the cycle 203.

In the cycle 203, the status read data SRD is input to the bus control circuit 3 and the bus control circuit 3 recognizes that the way0 is set in a hit state. Accordingly, it is necessary to update the LRU bit of the cache status to “0”. Moreover, access to the cache memory device 10 in the cycle 202 is the read access. Therefore, it is not necessary to update the data way0_valid bit, the way1_valid bit, the way0_dirty bit and the way1_dirty bit. Accordingly, the bus control circuit 3 writes “11000” as the cache status to the status memory 600 of the cache memory 6 of the bank n.

More specifically, as shown in FIG. 9, the bus control circuit 3 outputs the cache address ADR having the value of “A0” to the cache memory device 10, and outputs the status write data SWD having a value of “11000” and the cache memory control signal CMCNT at the same time in the cycle 203.

In this cycle, write access to the status memory 600 is executed. As shown in FIG. 9, therefore, both the bank n status access request signal BnSREQ and the bank n status write control signal BnSWCNT indicate “1”. In the status memory 600 of the cache memory 6 of the bank n, accordingly, “11000” is written to the address indicated by the index ID in the cache address ADR. Thus, the cache status is updated.

Next, the CPU 2 gives the bus control circuit 3 a request for giving read access to the cache memory 6 of the cache memory device 10. As shown in FIG. 9, the bus control circuit 3 receiving the request of the CPU 2 outputs the cache address ADR having the value of “A1” to the cache memory device 10 and outputs the cache memory control signal CMCNT at the same time in the cycle 205.

The bank control circuit 7 outputs the cache memory control signal CMCNT as the bank n control signal BnCNT to the cache memory 6 of the bank n in the selected cache memories 6 based on the signal BID included in the received cache address ADR.

As described above, in the cycle 206, data are read from the status memory 600, the tag memory 612 and the data memory 634 in the cache memory 6 of the bank n. As shown in FIGS. 9 to 12, values of the n status read data BnSRD, the bank n way0 tag read data Bnw0TRD, the bank n way1 tag read data Bnw1TRD, the bank n way0 read data Bnw0RD and the bank n way1 read data Bnw1RD which are read in the cycle 206 are set to be “11000”, “T01”, “T11”, “D01” and “D11”, respectively.

In the cycle 206, the flip-flop 512 of the cache peripheral circuit 5 outputs the tag TG in the cache address ADR input in the cycle 205. The value of the tag TG is set to be “T21”.

Since the output value “T21” of the flip-flop 512 is not coincident with the value “T01” of the way0 tag read data w0TRD, the comparator 500 outputs “0”. Since the output of the comparator 500 is “0”, the AND circuit 501 outputs “0”. As shown in FIG. 10, consequently, the way0 hit signal HIT0 is “0” in the cycle 206.

Since the output value “T00” of the flip-flop 512 is not coincident with the value “T01” of the way1 tag read data w1TRD, the comparator 502 outputs “0”. Since the output of the comparator 502 is “0”, the AND circuit 503 outputs “0”. As shown in FIG. 11, consequently, the way1 hit signal HIT1 is “0” in the cycle 206.

Since the data w0dy is “0”, the AND circuit 505 outputs “0”. As shown in FIG. 10, consequently, the way0 copy back signal CB0 is “0” in the cycle 206. Since the data w1dy is “0”, moreover, the AND circuit 508 outputs “0”. As shown in FIG. 11, consequently, the way1 copy back signal CB1 is “0” in the cycle 206.

Since both of the outputs of the AND circuits 501 and 505 are “0”, the OR circuit 509 outputs “0”. Since both of the outputs of the AND circuits 503 and 508 are “0”, the OR circuit 510 outputs “0”. Accordingly, the output of the selector 511 is undefined. As a result, as shown in FIG. 12, the value of the read data RD is undefined in the cycle 206.

The status read data SRD is input to the bus control circuit 3 and the bus control circuit 3 recognizes that both way0 and way1 are set in a mishit state (both the way0 hit signal HIT0 and the way1 hit signal HIT1 are “0”) and copy back is not required (both the way0 copy back signal CB0 and the way1 copy back signal CB1 are “0”) in the cycle 206. The cache status is not changed by the access executed in the cycle 205. Therefore, the cache status is not updated in the cycle 206.

Then, the bus control circuit 3 gives read access to the main memory 4 in order to obtain the copy data of the main memory 4. Thereafter, the bus control circuit 3 outputs the data read from the main memory 4 to the CPU 2 and writes the data to the cache memory 6 of the bank n. A value of the data read from the main memory 4 is set to be “DW1”.

The cycles 207 to 210 represent a period for which read access is given to the main memory 4 by the bus control circuit 3. For this period, access to the cache memory device 10 is not executed.

When reading the data “DW1” from the main memory 4, the bus control circuit 3 writes the data “DW1” to the cache memory 6 in the cycle 211. Since the bus control circuit 3 recognizes that the LRU bit indicates way0 from the status read data SRD input in the cycle 206, it writes the data “DW1” to the way1 data memory 604.

In the cycle 211, furthermore, the bus control circuit 3 updates the cache status and the tag TG in the cache memory 6. The bus control circuit 3 writes the data “DW1” to the way1 data memory 604. Therefore, it is necessary to update the LRU bit to “1”. Moreover, the copy data of the main memory 4 are written to the way1 data memory 604 and data are not written to the way0 data memory 603. For this reason, it is not necessary to update the way0_dirty bit and the way1_dirty bit. Moreover, since the data of the way1 data memory 604 are updated and are maintained to be valid, the way1_valid bit does not need to be updated. Since data are not written to the way0 data memory 603, it is not necessary to update the way0_valid bit. Accordingly, the bus control circuit 3 writes “11001” as the cache status to the status memory 600 of the cache memory 6 of the bank n.

An operation in the cycle 211 will be specifically described below.

As shown in FIG. 9, in the cycle 211, the bus control circuit 3 outputs the cache address ADR having the value of “A1” to the cache memory device 10 and outputs the status write data SWD having the value of “11001” and the cache memory control signal CMCNT at the same time. Furthermore, the bus control circuit 3 outputs the write data WD having a value of “DW1” in this cycle as shown in FIG. 12.

The bank n status access request signal BnSREQ indicates “1” and the bank n status write control signal BnSWCNT indicates “1”. In the status memory 600 of the cache memory 6 of the bank n, therefore, “11001” is written to the address indicated by the index ID in the cache address ADR. Thus, the cache status is updated.

In the cycle 211, moreover, both the bank n way1 tag access request signal BnTREQ1 and the bank n way1 tag write control signal BnTCNT1 indicate “1” as shown in FIG. 11. In the way1 tag memory 601 of the cache memory 6 of the bank n, accordingly, the tag TG in the cache address ADR is written to the address indicated by the index ID in the cache address ADR. Thus, the tag TG in the cache memory 6 is updated.

In the cycle 211, moreover, both the bank n way1 data access request signal BnDREQ1 and the bank n way1 data write control signal BnDCNT1 indicate “1” as shown in FIG. 12. In the way1 data memory 604 of the cache memory 6 of the bank n, accordingly, the data “DW1” are written to the address indicated by the index ID in the cache address ADR. Thus, the copy data of the main memory 4 are written to the cache memory 6.

Next, a write operation in the cache operation of the microprocessor 1 will be described with reference to FIGS. 13 to 15.

First of all, the CPU 2 gives the bus control circuit 3 a request for writing the data “DW2” to the cache memory 6 of the cache memory device 10. The bus control circuit 3 receiving the request of the CPU 2 gives read access to the status memory 600 and the tag memory 612 in the cache memory 6 prior to write access to the cache memory 6.

More specifically, as shown in FIG. 13, the bus control circuit 3 outputs the cache address ADR having a value of “A2” to the cache memory device 10 and outputs the cache memory control signal CMCNT at the same time in the cycle 214.

In the cycle 214, the bank n status access request signal BnSREQ indicates “1” and the bank n status write control signal BnSWCNT indicates “0”. Therefore, the read access is given to the status memory 600 of the cache memory 6 of the bank n. As a result, as shown in FIG. 13, data are read from the status memory 600 and are output as the bank n status read data BnSRD in the cycle 215. A value of the bank n status read data BnSRD read in the cycle 215 is set to be “11000”.

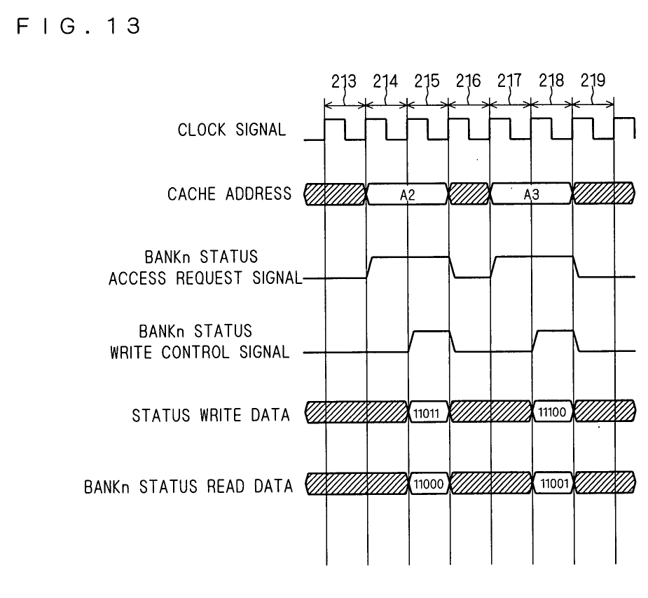

In the cycle 214, moreover, both the bank n way0 tag access request signal BnTREQ0 and the bank n way1 tag access request signal BnTREQ1 indicate “1” and both the bank n way0 tag write control signal BnTCNT0 and the bank n way1 tag write control signal BnTCNT1 indicate “0” as shown in FIG. 14. Accordingly, the read access is given to the tag memory 612 of the cache memory 6 of the bank n. As a result, in the cycle 215, data are read from the tag memory 612 and are output as the bank n way0 tag read data Bnw0TRD and the bank n way1 tag read data Bnw1TRD. Values of the bank n way0 tag read data Bnw0TRD and the bank n way1 tag read data Bnw1TRD which are read in the cycle 215 are set to be “T02” and “T12”, respectively.

In the cycle 215, the flip-flop 512 of the cache peripheral circuit 5 outputs the tag TG in the cache address ADR input in the cycle 214. The value of the tag TG is set to be “T12”.

Since the output value “T12” of the flip-flop 512 is not coincident with the value “T02” of the way0 tag read data w0TRD, the comparator 500 outputs “0”. Accordingly, the AND circuit 501 outputs “0”. As shown in FIG. 14, consequently, the way0 hit signal HIT0 is “0” in the cycle 215.

Since the output value “T12” of the flip-flop 512 is coincident with the value “T12” of the way1 tag read data w1TRD, the comparator 502 outputs “1”. As described above, the value of the bank n status read data BnSRD is “11000”. Therefore, the data w0vd is “1”. Accordingly, “1” is input to both inputs of the AND circuit 503 and the AND circuit 503 outputs “1”. As shown in FIG. 14, consequently, the way1 hit signal HIT1 is “1” in the cycle 215.

Since both the data w0dy and w1dy are “0”, the AND circuits 505 and 508 output “0” respectively. As shown in FIG. 14, consequently, the way0 copy back signal CB0 and the way1 copy back signal CB1 are “0” respectively in the cycle 215.

When receiving the outputs of the bank control circuit 7 and the cache peripheral circuit 5 in the cycle 215, the bus control circuit 3 writes the data “DW2” to the cache memory 6 of the bank n. Since the bus control circuit 3 recognizes that the way0 hit signal HIT0, the way1 hit signal HIT1, the way0 copy back signal CB0 and the way1 copy back signal CB1 indicate “0”, “1”, “0” and “0” respectively from the signal sent from the cache peripheral circuit 5 which is received in the cycle 215, it writes the data “DW2” to the way1 data memory 604.

Since data is written to the way1 data memory 604, moreover, it is necessary to update both the LRU bit and the way1_dirty bit to “1”. For this reason, the bus control circuit 3 writes “11011” as the cache status to the status memory 600 of the cache memory 6 of the bank n in the cycle 215.

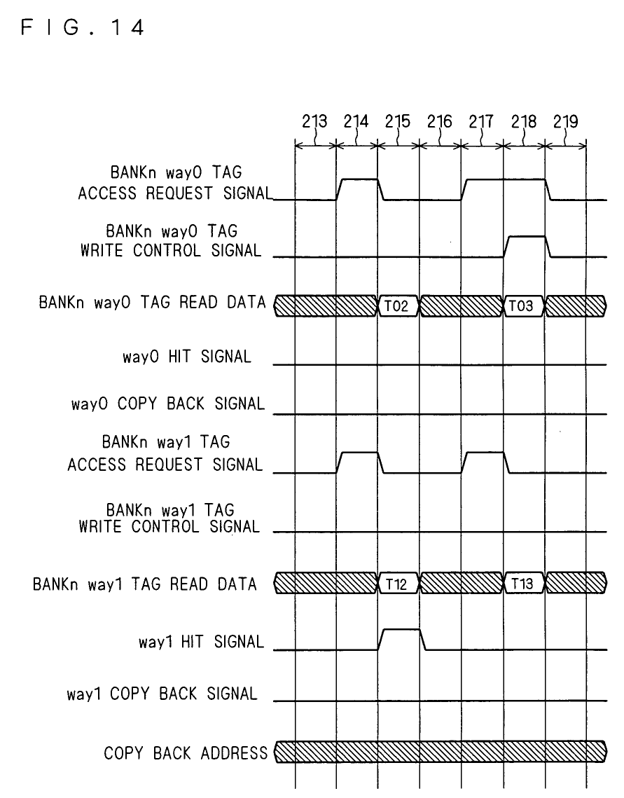

More specifically, as shown in FIG. 13, the bus control circuit 3 outputs the cache address ADR having the value of “A2” to the cache memory device 10 and outputs the status write data SWD having a value of “11011” and the cache memory control signal CMCNT at the same time in the cycle 215. Furthermore, the bus control circuit 3 outputs the write data WD having a value of “DW2” in this cycle as shown in FIG. 15.

Since both the bank n status access request signal BnSREQ and the bank n status write control signal BnSWCNT indicate “1”, “11011” is written to the status memory 600 of the cache memory 6 of the bank n. Thus, the cache status is updated.

In the cycle 215, moreover, both the bank n way1 data access request signal BnDREQ1 and the bank n way1 data write control signal BNDCNT1 indicate “1” as shown in FIG. 15. Accordingly, the data “DW2” are written to the way1 data memory 604 of the cache memory 6 of the bank n. Thus, the data of the way1 data memory 604 are updated.

Then, the CPU 2 gives the bus control circuit 3 a request for writing the data “DW3” to the cache memory 6 of the cache memory device 10. The bus control circuit 3 receiving the request of the CPU 2 gives read access to the status memory 600 and the tag memory 612 in the cache memory 6 prior to write access to the cache memory 6 in the cycle 217 as described above. As a result, in the cycle 218, data are read from the status memory 600 and the tag memory 612 in the cache memory 6 of the bank n. As shown in FIGS. 13 and 14, values of the bank n status read data BnSRD, the bank n way0 tag read data Bnw0TRD and the bank n way1 tag read data Bnw1TRD which are read in the cycle 218 are set to be “11001”, “T03” and “T13”, respectively.

In the cycle 218, the flip-flop 512 of the cache peripheral circuit 5 outputs the tag TG in the cache address ADR input in the cycle 217. The value of the tag TG is set to be “T23”.

Since the output value “T23” of the flip-flop 512 is not coincident with the value “T03” of the way0 tag read data w0TRD, the comparator 500 outputs “0”. As shown in FIG. 14, consequently, the way0 hit signal HIT0 is “0” in the cycle 218.

Since the output value “T23” of the flip-flop 512 is not coincident with the value “T13” of the way1 tag read data w1TRD, the comparator 502 outputs “0”. As shown in FIG. 14, consequently, the way1 hit signal HIT1 is “0” in the cycle 218.

Since both of the data w0dy and w1dy are “0”, the AND circuits 505 and 508 output “0” respectively. As shown in FIG. 14, consequently, the way0 copy back signal CB0 and the way1 copy back signal CB1 are “0” respectively in the cycle 218.

When receiving the outputs of the bank control circuit 7 and the cache peripheral circuit 5 in the cycle 218, the bus control circuit 3 writes the data “DW3” to the cache memory 6 of the bank n as described above. The bus control circuit 3 recognizes that all of the way0 hit signal HIT0, the way1 hit signal HIT1, the way0 copy back signal CB0 and the way1 copy back signal CB1 indicate “0” from the signal sent from the cache peripheral circuit 5 which is received in the cycle 218. Furthermore, the bus control circuit 3 recognizes that the LRU bit indicates the way1 from the status read data SRD input in the cycle 218. Accordingly, the bus control circuit 3 writes the data “DW3” to the way0 data memory 603.

Since data is written to the way0 data memory 603, moreover, it is necessary to update the LRU bit to “0” and the way0_dirty bit to “1”. In the cycle 218, accordingly, the bus control circuit 3 writes “11100” as the cache status to the status memory 600 of the cache memory 6 of the bank n.

Next, the operation of the microprocessor 1 in the generation of the copy back during the read operation will be described with reference to FIGS. 16 to 19.

First of all, the CPU 2 gives the bus control circuit 3 a request for giving read access to the cache memory 6 of the cache memory device 10. As shown in FIG. 16, the bus control circuit 3 receiving the request of the CPU 2 outputs the cache address ADR having a value of “A4” to the cache memory device 10 and outputs the cache memory control signal CMCNT at the same time in the cycle 221.

As described above, in the cycle 222, data are read from the status memory 600, the tag memory 612 and the data memory 634 in the cache memory 6 of the bank n. As shown in FIGS. 16 to 19, values of the bank n status read data BnSRD, the bank n way0 tag read data Bnw0TRD, the bank n way1 tag read data Bnw1TRD, the bank n way0 read data Bnw0RD and the bank n way1 read data Bnw1RD which are read in the cycle 222 are set to be “11101”, “T04”, “T14”, “D04” and “D14”, respectively.

In the cycle 222, the flip-flop 512 of the cache peripheral circuit 5 outputs the tag TG in the cache address ADR input in the cycle 221. The value of the tag TG is set to be “T24”.

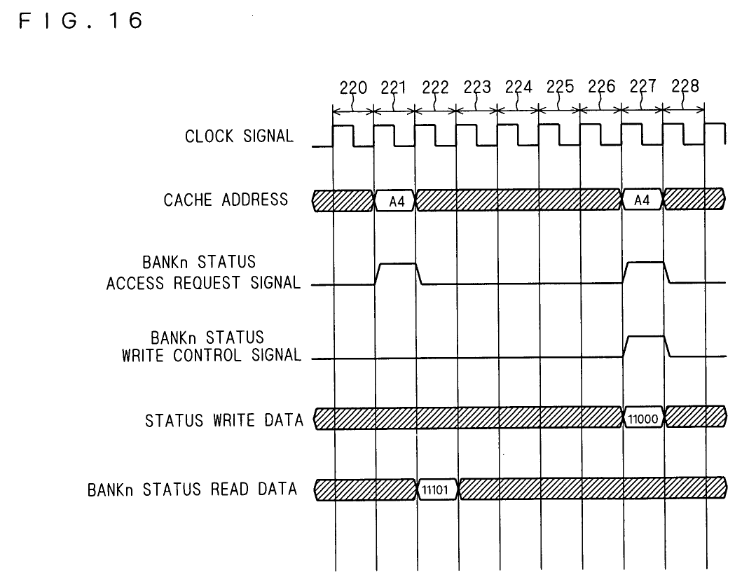

Since the output value “T24” of the flip-flop 512 is not coincident with the value “T04” of the way0 tag read data w0TRD, the comparator 500 outputs “0”. Accordingly, the AND circuit 501 outputs “0”. As shown in FIG. 17, consequently, the way0 hit signal HIT0 is “0” in the cycle 222.

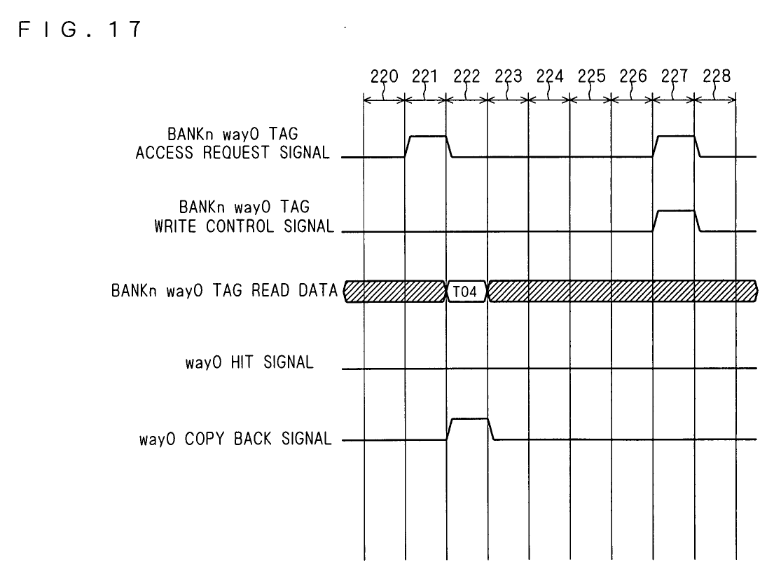

Since the output value “T24” of the flip-flop 512 is not coincident with the value “T04” of the way1 tag read data w1TRD, the comparator 502 outputs “0”. Accordingly, the AND circuit 503 outputs “0”. As shown in FIG. 18, consequently, the way1 hit signal HIT1 is “0” in the cycle 222.

Since the output of the AND circuit 501 is “0”, the inverter 504 outputs “1”. Since both the data w0dy and the LRU are “1”, all of the inputs of the AND circuit 505 are “1”. Accordingly, the AND circuit 505 outputs “1”. As shown in FIG. 17, consequently, the way0 copy back signal CB0 is “1” in the cycle 222. Since the data w1dy is “0”, moreover, the AND circuit 508 outputs “0”. As shown in FIG. 18, consequently, the way1 copy back signal CB1 is “0” in the cycle 206.

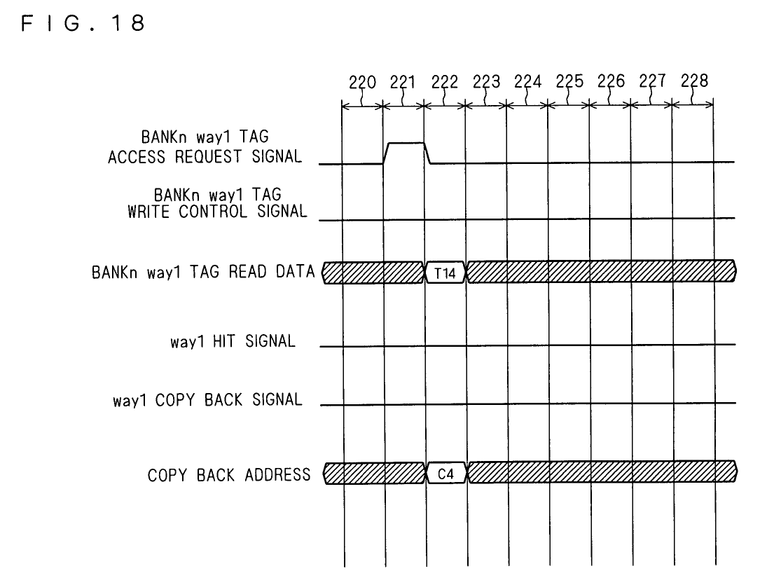

Since the output of the AND circuit 505 is “1”, the OR circuit 509 outputs “1”. Since both of the outputs of the AND circuits 503 and 508 are “0”, the OR circuit 510 outputs “0”. Accordingly, the selector 511 selects the way0 read data w0RD. As a result, as shown in FIG. 19, “D04” is output as the read data RD to the bus control circuit 3 in the cycle 222.

Since the output of the AND circuit 505 is “1” and the output of the AND circuit 508 is “0”, the selector 514 outputs the way0 tag read data w0TRD having a value of “T04”. The linking device 515 links the output value “T04” of the selector 514 to the index in the cache address ADR which is output from the flip-flop 513, and outputs the result as the copy back address CADR to the bus control circuit 3. A value of the copy back address CADR output in the cycle 222 is set to be “C4”.

In the cycle 222, the bus control circuit 3 recognizes that the way0 copy back signal CB0 is “1”. Accordingly, the bus control circuit 3 writes the received data “D04” to a predetermined block of the main memory 4 by setting the copy back address CADR to be the address of the main memory 4. The writing operation is referred to as “copy back”.

Since both of the way0 hit signal HIT0 and the way1 hit signal HIT1 are “0”, the bus control circuit 3 reads data from the predetermined block of the main memory 4 indicated by an address value of “A4”. In this case, a value of the data read from the main memory 4 is set to be “DW4”.

The cycles 223 to 226 represent a period for which read access is given to the main memory 4 by the bus control circuit 3. For this period, access to the cache memory device 10 is not executed.

When reading the data “DW4” from the main memory 4, the bus control circuit 3 writes the data “DW4” to the way0 data memory 603 setting the value of the cache address ADR to be “A4” in the cycle 227.

In the cycle 227, furthermore, the bus control circuit 3 updates the cache status and the tag TG in the cache memory 6. The bus control circuit 3 writes the data “DW4” to the way0 data memory 603. Therefore, it is necessary to update the LRU bit to “0”. Moreover, the copy data of the main memory 4 are written to the way0 data memory 603. For this reason, it is necessary to update the way0_dirty bit to “0”. Accordingly, the bus control circuit 3 writes “11000” as the cache status to the status memory 600 of the cache memory 6 of the bank n.

As described above, the copy back is carried out during the read operation.

Next, the operation of the microprocessor 1 to be carried out when the different cache memories 6 are to be continuously accessed will be described with reference to FIGS. 20 and 21.

FIGS. 20 and 21 show an operation timing in the case in which a value of the signal CSIZE is set to be “11” and the status memory 600 of each cache memory 6 is to be read accessed. First of all, the bus control circuit 3 outputs the cache address ADR having a value of “A10” and outputs the cache memory control signal CMCNT at the same time in the cycle 302.

At this time, as shown in FIG. 20, the signal BID indicates “000” and the status access request signal in the cache memory control signal CMCNT indicates “1”. Accordingly, the bank decoder 700 of the bank control circuit 7 sets only the bank 0 selection signal B0SEL to be “1”. As a result, the cache memory control signal CMCNT is output as the bank 0 control signal B0CNT. For this reason, as shown in FIG. 20, only the bank 0 status access request signal B0SREQ is set to be “1” in the cycle 302. In the cycle 302, the bank 0 status write control signal B0SWCNT is “0”, which is not shown.

When the bank 0 status access request signal B0SREQ is “1” and the bank 0 status write control signal B0SWCNT is “0”, data are read from the status memory 600 of the cache memory 6 of the bank 0 in the cycle 303 and are input as the bank 0 status read data B0SRD to the bank control circuit 7. A value of the bank 0 status read data B0SRD is set to be “RD0”.

Since only the bank 0 selection signal B0SEL indicates “1”, the output of only the flip-flop 709 in the flip-flops 709 to 716 of the bank control circuit 7 indicates “1”. As shown in FIG. 21, accordingly, the bank 0 status read data B0SRD are input as the status read data SRD to the bus control circuit 3 in the cycle 303.

In the cycle 303, moreover, the bus control circuit 3 outputs the cache address ADR having a value of “A11” and outputs the cache memory control signal CMCNT at the same time as shown in FIG. 20.

At this time, the signal BID indicates “001” and the status access request signal in the cache memory control signal CMCNT indicates “1”. Accordingly, the bank decoder 700 of the bank control circuit 7 sets only the bank 1 selection signal B1SEL to be “1”. As a result, the cache memory control signal CMCNT is output as the bank 1 control signal B1CNT. For this reason, as shown in FIG. 20, only the bank 1 status access request signal B1SREQ is “1” in the cycle 303. In the cycle 303, the bank 1 status write control signal B1SWCNT is “0”, which is not shown.

When the bank 1 status access request signal B1SREQ is “1” and the bank 1 status write control signal B1SWCNT is “0”, data are read from the status memory 600 of the cache memory 6 of the bank 1 and are input as the bank 1 status read data B1SRD to the bank control circuit 7 in the cycle 304. A value of the bank 1 status read data B1SRD is set to be “RD1”.

Since only the bank 1 selection signal B1SEL indicates “1”, the output of only the flip-flop 710 in the flip-flops 709 to 716 of the bank control circuit 7 indicates “1”. As shown in FIG. 21, accordingly, the bank 1 status read data B1SRD are input as the status read data SRD to the bus control circuit 3 in the cycle 304.

In the cycle 304, moreover, the bus control circuit 3 outputs the cache address ADR having a value of “A12” and outputs the cache memory control signal CMCNT at the same time as shown in FIG. 20.

At this time, the signal BID indicates “010” and the status access request signal in the cache memory control signal CMCNT indicates “1”. Accordingly, the bank decoder 700 of the bank control circuit 7 sets only the bank 2 selection signal B2SEL to be “1”. As a result, the cache memory control signal CMCNT is output as the bank 2 control signal B2CNT. For this reason, as shown in FIG. 20, only the bank 2 status access request signal B2SREQ is “1” in the cycle 304. In the cycle 304, the bank 2 status write control signal B2SWCNT is “0”, which is not shown.

When the bank 2 status access request signal B1SREQ is “1” and the bank 2 status write control signal B2SWCNT is “0”, data are read from the status memory 600 of the cache memory 6 of the bank 2 in the cycle 305 and are input as the bank 2 status read data B2SRD to the bank control circuit 7. A value of the bank 2 status read data B2SRD is set to be “RD2”.

Since only the bank 2 selection signal B2SEL indicates “1”, the output of only the flip-flop 711 in the flip-flops 709 to 716 of the bank control circuit 7 indicates “1”. As shown in FIG. 21, accordingly, the bank 2 status read data B2SRD are input as the status read data SRD to the bus control circuit 3 in the cycle 305.

Thus, the status memories 600 of the cache memories 6 of the banks 0 to 7 are sequentially read accessed and the bank 0 status read data B0SRD to the bank 7 status read data B7SRD are sequentially input as the status read data SRD to the bus control circuit 3 as shown in FIG. 21.

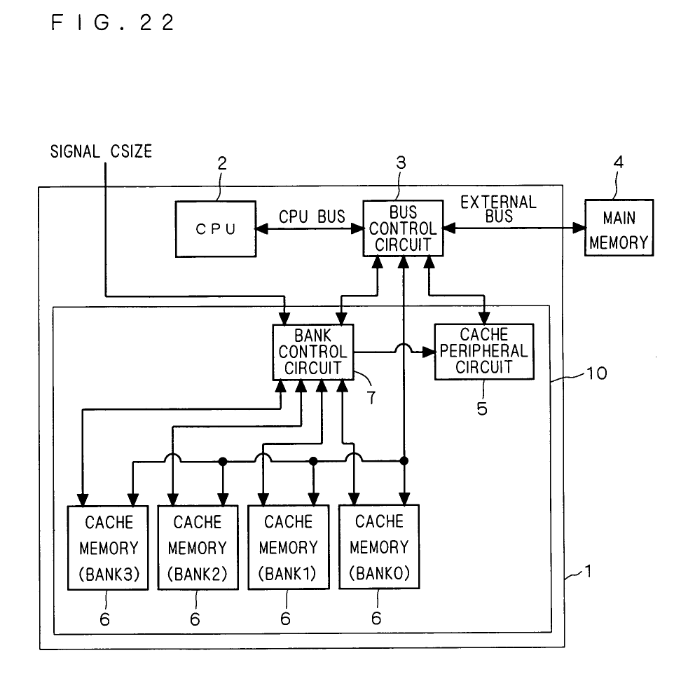

While the eight cache memories 6 are connected to the bank control circuit 7 in the above description, four cache memories 6 of the banks 0 to 3 may be connected to the bank control circuit 7 as shown in FIG. 22 if a cache capacity of 8 K bytes is required at a maximum. In this case, it is possible to implement a cache capacity of 2 K bytes, 4K bytes or 8 K bytes by setting the value of the signal CSIZE to be “00”, “01” or “10”.

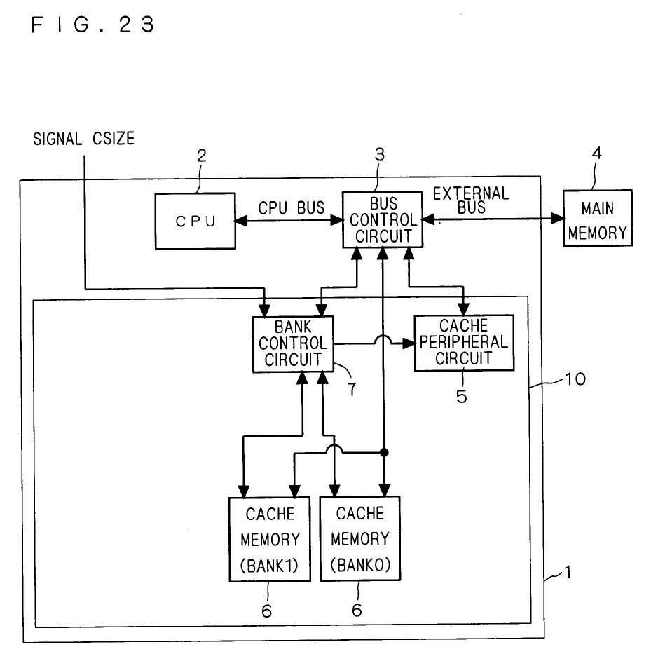

If only the cache capacity of 4 K bytes is required at a maximum, moreover, two cache memories 6 of the banks 0 and 1 may be connected to the bank control circuit 7 as shown in FIG. 23. In this case, it is possible to implement a cache capacity of 2 K bytes or 4 K bytes by setting the value of the signal CSIZE to be “00” or “01”.

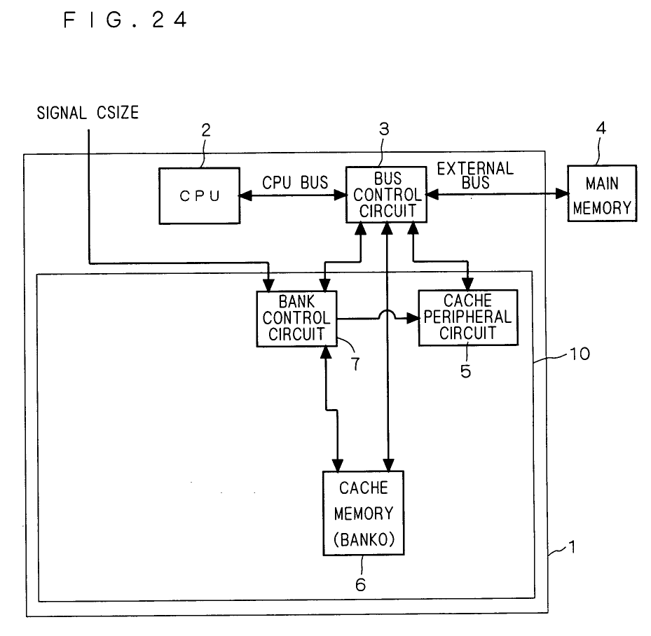

If only the cache capacity of 2 K bytes is required, furthermore, only the cache memory 6 of the bank 0 may be connected to the bank control circuit 7 as shown in FIG. 24. In this case, it is possible to implement the cache capacity of 2 K bytes by fixing the value of the signal CSIZE to be “00”.

In the case in which seven cache memories 6 or less are to be connected to the bank control circuit 7, it is desirable that any of input terminals for the bank 0 read data B0RD to the bank 7 read data B7RD which is not connected to the cache memory 6 should have an electric potential fixed in order to enhance a stability of an operation of the bank control circuit 7.

In the cache memory device 10 according to the first embodiment, thus, the bank control circuit 7 for controlling access to the cache memories 6 is provided. Therefore, it is possible to fix a bit position occupied by the tag TG and the index ID in the cache address ADR irrespective of the cache capacity as in the first embodiment.

In the conventional art, there is not provided a circuit capable of controlling the access to the cache memories 6, for example, the bank control circuit 7 according to the first embodiment. In the case in which the cache capacity is to be increased, therefore, a plurality of cache memories 6 cannot be provided, so that it is necessary to increase the memory capacities of the way0 data memory 603 and the way1 data memory 604 in the cache memory 6.

The way0 data memory 603 and the way1 data memory 604 set the index ID in the cache address to be an address as described above. In order to increase their memory capacities, therefore, it is necessary to increase the bit number of the index ID in the cache address ADR, thereby increasing an address width. Furthermore, the bit number of the cache address depends on the address width of the main memory 4. For this reason, if the bit number of the index ID is increased, the bit number of the tag TG is decreased.

In the case in which the cache capacity is increased, accordingly, it is necessary to change a design of the flip-flop 513 of the cache peripheral circuit 5 utilizing the index ID, the flip-flop 512 utilizing the tag TG, the comparators 500 and 502 and the selector 514, and the linking device 515 utilizing the tag TG and the index ID. In particular, a long time is taken for changing the design of the comparators 500 and 502.

In the first embodiment, the bank control circuit 7 is provided in the cache memory device 10, so that a plurality of cache memories 6 can be mounted. As a result, as in the first embodiment, it is possible to change the cache capacity without varying the memory capacities of the way0 data memory 603 and the way1 data memory 604 in the cache memory 6. Consequently, it is possible to always fix the bit positions of the tag TG and the index ID in the cache address ADR. Also in the case in which the cache capacity is changed, accordingly, it is not necessary to change the design of the cache peripheral circuit 5. Thus, it is possible to reduce the change in the design which is required for varying the cache capacity.

In the technique described in the Patent Document 1, moreover, the number of ways of the cache memory device, that is, a degree of association is changed to vary the cache capacity of the cache memory device, resulting in a reduction in the change in the design which is required for varying the cache capacity. In the case in which the technique described in the Patent Document 1 is employed for varying the cache capacity, however, there is the following problem.

In the first embodiment, the LRU method utilizing a temporal locality of data reference is employed for a data replacement method in mishit. In the case in which the LRU method is employed, generally, the number of saved histories is increased if the number of the ways is increased. Consequently, it is hard to carry out the data replacement in a short time. In the case in which the cache capacity is to be changed with a variation in the number of the ways as in the technique described in the Patent Document 1, accordingly, a cache performance is gradually deteriorated with an increase in the cache capacity. For this reason, it is hard to employ the LRU method for the data replacement method.

In the technique described in the Patent Document 1, the LRU method is not employed but a control method utilizing a register indicative of a cash unit accessed most newly which is referred to as a pointer register is employed for the data replacement method. In the control method, however, a result of a decision of a comparator is masked with a value indicated by the pointer register. In some cases, therefore, mishit might be caused in an address in which hit is to be originally carried out. Consequently, a hit rate is reduced.

Furthermore, the mishit is caused in the address in which the hit is to be originally carried out. For this reason, valid data which have already been written to a certain cache unit are written to another cash unit again and contents of the same column address are written to a plurality of cache units. Accordingly, the memory is not effectively utilized as the cache memory. The cache memory in the Patent Document 1 corresponds to the way0 data memory 603 and the way1 data memory 604 in the first embodiment, and the number of cache units (UNIT) and the column address in the Patent Document 1 correspond to the number of the ways and the index in the first embodiment, respectively.

In the technique described in the Patent Document 1, thus, easiness of a change in the cache capacity is implemented at the sacrifice of the cache performance.

On the other hand, in the first embodiment, by the action of the bank control circuit 7, the number of the cache memories 6 is changed so that the cache capacity can be varied. Therefore, it is not necessary to change the number of the ways. As in the first embodiment, accordingly, the LRU method can be employed for the data replacement method and the easiness of the change in the cache capacity can be implemented without sacrificing the cache performance.

In the first embodiment, moreover, the bank control circuit 7 can select the cache memory 6 based on the signal CSIZE indicative of the cache capacity. As in the first embodiment, therefore, it is possible to easily implement plural kinds of cache capacities by changing the value of the signal CSIZE. Accordingly, the design of the cache peripheral circuit 5 does not need to be changed so that the change in the design required for varying the cache capacity can be reduced.

Moreover, only one cache memory 6 is accessed through one read accessing operation or one write accessing operation by the action of the bank control circuit 7. Consequently, power consumption of the cache memory device 10 can be reduced.

Since a plurality of cache memories 6 provided in the cache memory device 10 have the memory capacities equal to each other, furthermore, they can be constituted by identical circuits to each other as in the first embodiment. Accordingly, the cache memory device 10 can be designed more easily than that in the case in which the memory capacities of the cache memories 6 are different from each other.

In addition, the microprocessor comprises the cache memory device 10 having the bank control circuit 7 as in the first embodiment. Consequently, microprocessors having various cache capacities can be obtained easily.

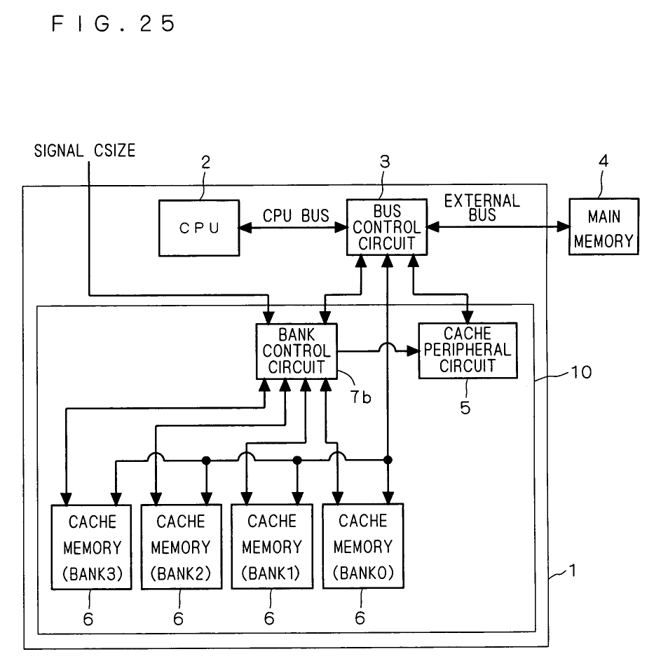

The bank control circuit 7 according to the first embodiment can be connected to the eight cache memories 6. In the case in which only the cache capacity of 8 K bytes at a maximum is required, it is also possible to provide the cache memories 6 of the banks 0 to 3 and to provide a bank control circuit 7b which can be connected to the four cache memories 6 in place of the bank control circuit 7 as shown in FIG. 25.

In the case in which only the cache capacity of 4 K bytes at a maximum is required, moreover, it is also possible to provide the cache memories 6 of the banks 0 and 1 and to provide a bank control circuit 7c which can be connected to the two cache memories 6 in place of the bank control circuit 7 as shown in FIG. 26.

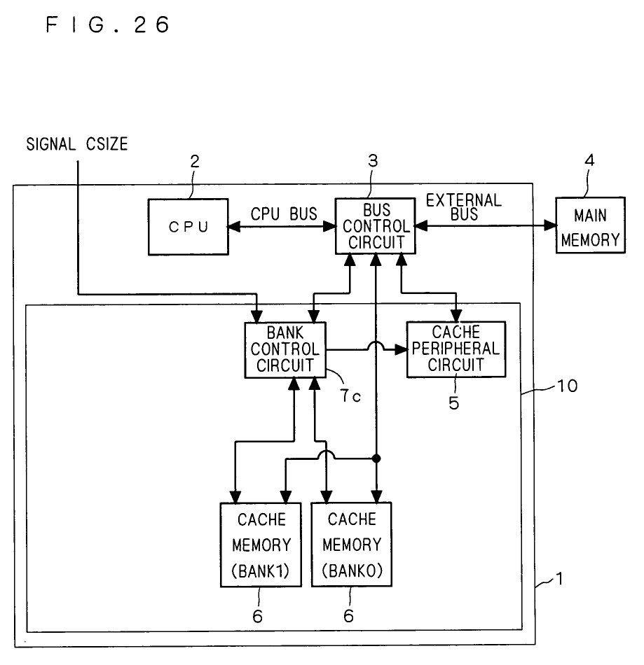

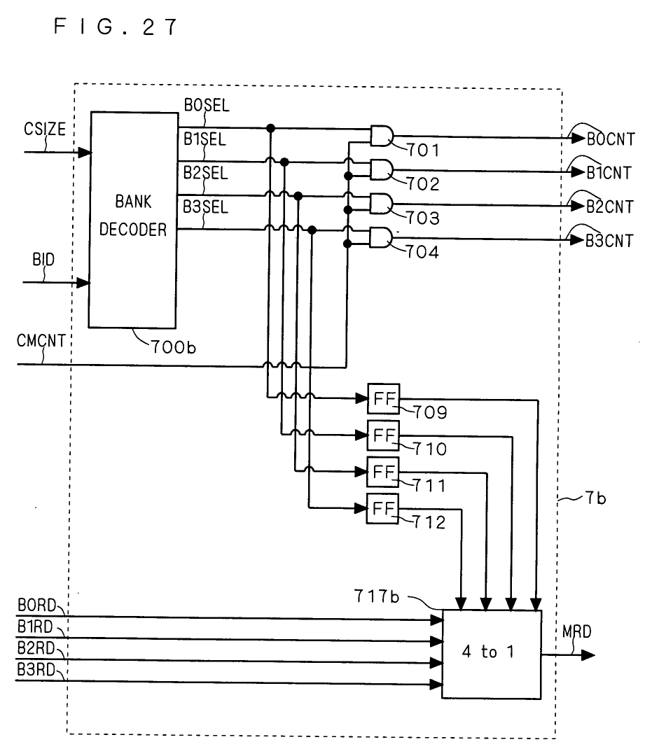

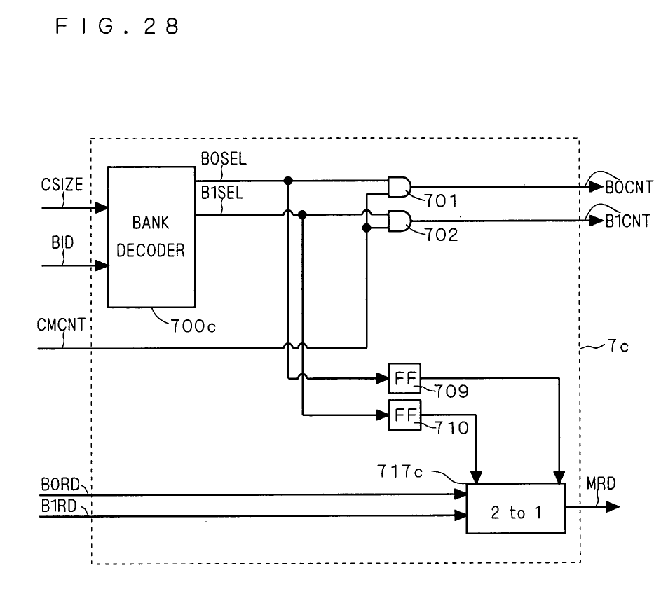

FIG. 27 is a circuit diagram showing a structure of the bank control circuit 7b and FIG. 28 is a circuit diagram showing a structure of the bank control circuit 7c. As shown in FIG. 27, the bank control circuit 7b comprises a bank decoder 700b, the AND circuits 701 to 704, the flip-flops 709 to 712, and a selector 717b.

The bank decoder 700b outputs the bank 0 selection signal B0SEL to the bank 3 selection signal B3SEL based on the signal CSIZE and the signal BID.

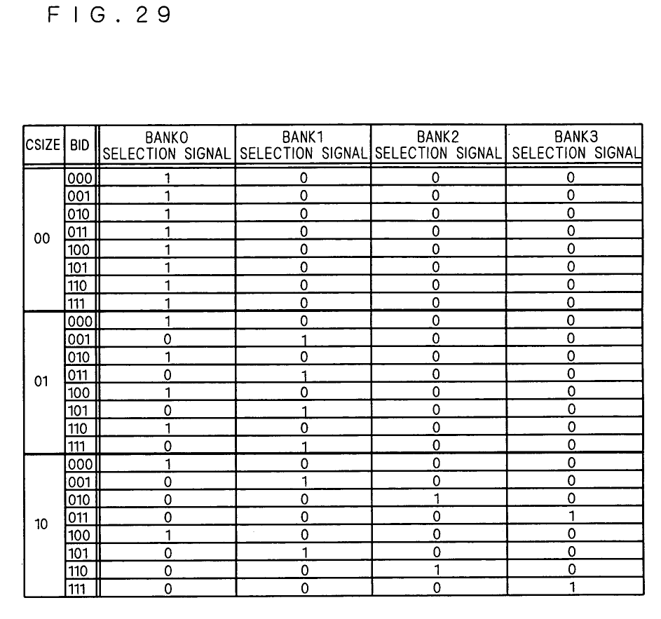

FIG. 29 is a diagram showing a relationship among the signal CSIZE, the signal BID and the bank n selection signal BnSEL (n=0 to 3). As shown in FIG. 29, when the signal CSIZE is “00”, only the bank 0 selection signal B0SEL is always “1” and the bank 1 selection signal B1SEL to the bank 3 selection signal B3SEL are always “0” irrespective of a value of the signal BID. In the case in which the signal CSIZE is “01”, only the bank 0 selection signal B0SEL is “1” when a least significant bit of the signal BID is “0” and only the bank 1 selection signal B1SEL is “1” when the least significant bit of the signal BID is “1”.

In the case in which the signal CSIZE is “10”, moreover, only the bank 0 selection signal B0SEL is “1” when 2 lower bits of the signal BID is “00”, only the bank 1 selection signal B1SEL is “1” when the 2 lower bits of the signal BID is “01”, only the bank 2 selection signal B2SEL is “1” when the 2 lower bits of the signal BID is “10”, and only the bank 3 selection signal B3SEL is “1” when the 2 lower bits of the signal BID is “11”. In the case in which the signal CSIZE is “11”, the respective values of the bank 0 selection signal B0SEL to the bank 3 selection signal B3SEL are undefined.

The AND circuits 701 to 704 calculate logical products of the bank 0 selection signal B0SEL to the bank 3 selection signal B3SEL and the cache memory control signal CMCNT respectively, and output them as the bank 0 control signal B0CNT to the bank 3 control signal B3CNT respectively.

The bank 0 selection signal B0SEL to the bank 3 selection signal B3SEL are input to the flip-flops 709 to 712, respectively. A clock signal CLK which is not shown is also input to the flip-flops 709 to 712. The flip-flops 709 to 712 delay the input signals for the time corresponding to one clock cycle of the clock signal CLK and output the results.

The bank 0 read data B0RD to the bank 3 read data B3RD and outputs of the flip-flops 709 to 712 are input to the selector 717b. The selector 717b outputs the bank 0 read data B0RD as the memory read data MRD when the output of the flip-flop 709 is exclusively “1”, outputs the bank 1 read data B1RD as the memory read data MRD when the output of the flip-flop 710 is exclusively “1”, outputs the bank 2 read data B2RD as the memory read data MRD when the output of the flip-flop 711 is exclusively “1”, and outputs the bank 3 read data B3RD as the memory read data MRD when the output of the flip-flop 712 is exclusively “1”.

In the case in which all the outputs of the flip-flops 709 to 712 are “0” or at least two outputs are “1”, the output of the selector 717b is undefined.

In the case in which only the cache memories 6 of the banks 0 to 3 are mounted, thus, the bank control circuit 7b which can be connected to four cache memories 6 may be provided in place of the bank control circuit 7.

The bank control circuit 7c in FIG. 26 comprises a bank decoder 700c, the AND circuits 701 and 702, the flip-flops 709 and 710, and a selector 717c as shown in FIG. 28.

The bank decoder 700c outputs the bank 0 selection signal B0SEL and the bank 1 selection signal B1SEL based on the signal CSIZE and the signal BID.

FIG. 30 is a diagram showing a relationship among the signal CSIZE, the signal BID and the bank n selection signal BnSEL (n=0, 1). As shown in FIG. 30, when the signal CSIZE is “00”, only the bank 0 selection signal B0SEL is always “1” and the bank 1 selection signal B1SEL is always “0” irrespective of the value of the signal BID. In the case in which the signal CSIZE is “01”, only the bank 0 selection signal B0SEL is “1” when the least significant bit of the signal BID is “0” and only the bank 1 selection signal B1SEL is “1” when the least significant bit of the signal BID is “1”.

In the case in which the signal CSIZE is “10” or “11”, the respective values of the bank 0 selection signal B0SEL and the bank 1 selection signal B1SEL are undefined.

The AND circuits 701 and 702 calculate logical products of the bank 0 selection signal B0SEL and bank 1 selection signal B1SEL and the cache memory control signal CMCNT respectively, and output them as the bank 0 control signal B0CNT and the bank 1 control signal B1CNT respectively.

The bank 0 selection signal B0SEL and the bank 1 selection signal B1SEL are input to the flip-flops 709 and 710, respectively. The clock signal CLK which is not shown is also input to the flip-flops 709 and 710. The flip-flops 709 and 710 delay the input signals for the time corresponding to one clock cycle of the clock signal CLK and output the results.

The bank 0 read data B0RD and the bank 1 read data B1RD and outputs of the flip-flops 709 and 710 are input to the selector 717c. The selector 717c outputs the bank 0 read data B0RD as the memory read data MRD when the outputs of the flip-flops 709 and 710 are “1” and “0” respectively, and outputs the bank 1 read data BIRD as the memory read data MRD when the outputs of the flip-flops 709 and 710 are “0” and “1” respectively. In the case in which both of the outputs of the flip-flops 709 and 710 are “0” or “1”, the output of the selector 717c is undefined.

In the case in which only the cache memories 6 of the banks 0 and 1 are mounted, thus, the bank control circuit 7c which can be connected to two cache memories 6 may be provided in place of the bank control circuit 7.

As described above, it is possible to reduce a circuit scale of the microprocessor 1 by changing the bank control circuit depending on the number of the cache memories 6 to be mounted on the cache memory device 10.

In the cache memory device 10 according to the first embodiment, moreover, all the bits of the tag TG in the cache address ADR are stored in the tag memory 612 of each cache memory 6. In the case in which all of the mounted cache memories are used, that is, the bank control circuit selects all of the cache memories 6, however, a part of the data to be stored in the tag memory 612 of each cache memory 6 can have a fixed value.

As shown in FIG. 6, in the case in which the bank control circuit 7 selects all of the cache memories 6, that is, the signal CSIZE indicates “11”, only the bank 0 selection signal B0SEL is “1” and only the cache memory 6 of the bank 0 is accessed when the signal BID to be a part of the tag TG is “000”. Moreover, when the signal BID is “001”, only the bank 1 selection signal B1SEL is “1” and only the cache memory 6 of the bank 1 is accessed.

In the case in which the bank control circuit 7 selects all of the cache memories 6, thus, the signal BID corresponds to a bank number of the cache memory 6 to be accessed one-on-one. In the tag memory 612 of each cache memory 6, accordingly, fixed data peculiar to each cache memory 6 corresponding to the signal BID can be stored in a memory area to which the signal BID included in the tag TG is to be written.

More specifically, in 3 lower bits of the memory area in each address of the tag memory 612, “000” is stored in the cache memory 6 of the bank 0 and “001” is stored in the cache memory 6 of the bank 1. Moreover, “010” is stored in the cache memory 6 of the bank 2 and “011” is stored in the cache memory 6 of the bank 3. Furthermore, “100” is stored in the cache memory 6 of the bank 4 and “101” is stored in the cache memory 6 of the bank 5. In addition, “110” is stored in the cache memory 6 of the bank 6 and “111” is stored in the cache memory 6 of the bank 7.

Thus, the tag memory of each cache memory 6 stores the fixed data peculiar to the cache memory 6, so that the bit number can be reduced in the write of the tag TG to the tag memory 612. In other words, all of the data of the tag TG constituted by 22 bits do not need to be written but it is preferable that only data of 19 upper bits of the tag TG, that is, only data of 0th to 18th bits of the cache address ADR should be written. Accordingly, a connecting wiring of the cache memory 6 and the bus control circuit 3 can be simplified.

For a method of storing the fixed data in the tag memory 612 of the cache memory 6, it is also possible to employ a method of fixing an electric potential of any of the data input terminals of the tag memory 612 to which 3 lower bits of input data are to be input and inputting 19 upper bits of the tag TG to other data input terminals, for example.

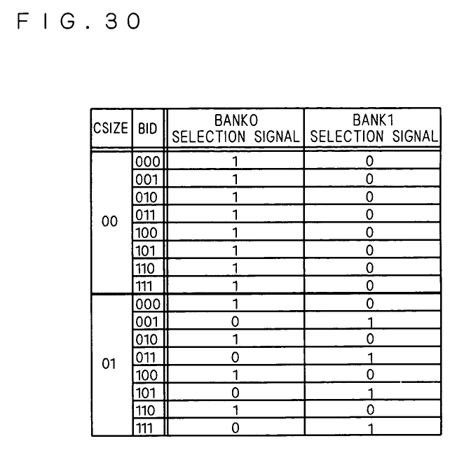

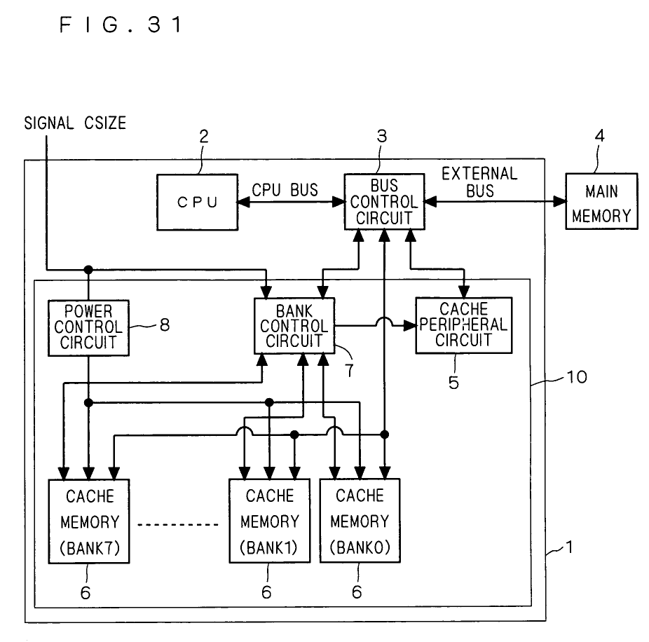

As shown in FIG. 31, moreover, a power control circuit 8 for controlling power supply to each cache memory 6 based on the signal CSIZE may be provided in the cache memory device 10 according to the first embodiment.

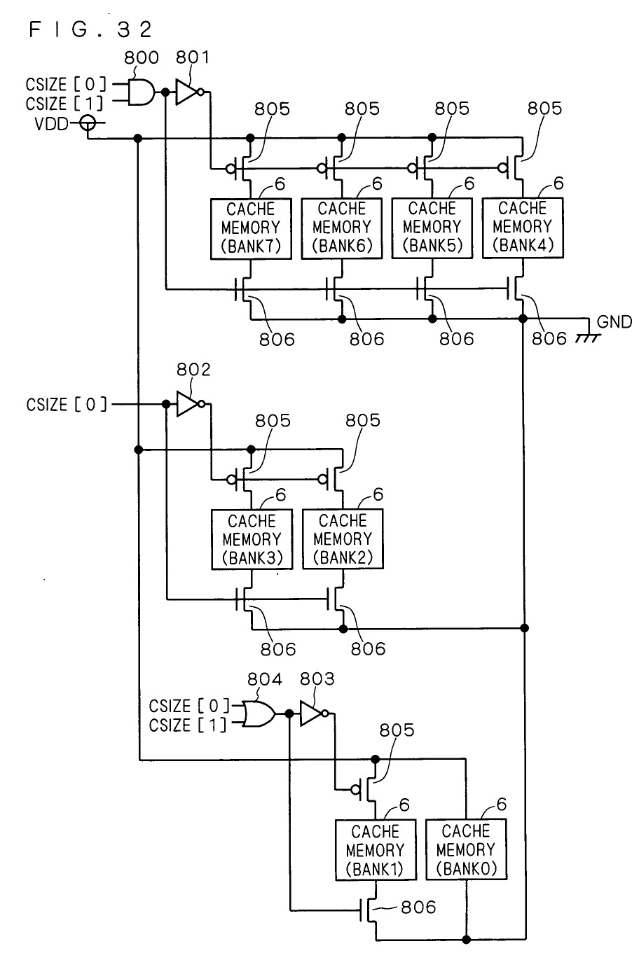

FIG. 32 is a circuit diagram showing a structure of the power control circuit 8. As shown in FIG. 32, the power control circuit 8 comprises an AND circuit 800, inverters 801 to 803, an OR circuit 804, and transistor switches 805 and 806. Upper and lower bit signals of the signal CSIZE will be referred to as signals CSIZE[0] and CSIZE[1], respectively.

The AND circuit 800 calculates and outputs a logical product of the signals CSIZE[0] and CSIZE[1]. The inverter 801 inverts an output of the AND circuit 800 and outputs the inverted output.

The inverter 802 inverts the signal CSIZE[0] and outputs the result. The OR circuit 804 calculates and outputs a logical sum of the signals CSIZE[0] and CSIZE[1]. The inverter 803 inverts an output of the OR circuit 804 and outputs the inverted output.

The transistor switches 805 and 806 are provided corresponding to the cache memories 6 of the banks 1 to 7, respectively. A power potential VDD to be a positive power potential of the cache memory 6 is input to each transistor switch 805. Moreover, a ground potential GND to be a negative power potential of the cache memory 6 is input to each transistor switch 806.

When the inverter 801 outputs “0”, each of the transistor switches 805 provided corresponding to the cache memories 6 of the banks 4 to 7 is turned ON and supplies the power potential VDD to the corresponding cache memory 6. Then, when the inverter 801 outputs “1”, the transistor switch 805 is turned OFF and stops the supply of the power potential VDD to the corresponding cache memory 6.

When the AND circuit 800 outputs “1”, each of the transistor switches 806 provided corresponding to the cache memories 6 of the banks 4 to 7 is turned ON and supplies the ground potential GND to the corresponding cache memory 6. Then, when the AND circuit 800 outputs “0”, the transistor switch 806 is turned OFF and stops the supply of the ground potential GND to the corresponding cache memory 6.

When the inverter 802 outputs “0”, each of the transistor switches 805 provided corresponding to the banks 2 and 3 is turned ON and supplies the power potential VDD to the corresponding cache memory 6. Then, when the inverter 802 outputs “1”, the transistor switch 805 is turned OFF and stops the supply of the power potential VDD to the corresponding cache memory 6.

When the signal CSIZE[0] indicates “1”, each of the transistor switches 806 provided corresponding to the banks 2 and 3 is turned ON and supplies the ground potential GND to the corresponding cache memory 6. Then, when the signal CSIZE[1] indicates “0”, the transistor switch 806 is turned OFF and stops the supply of the ground potential GND to the corresponding cache memory 6.

When the inverter 803 outputs “0”, the transistor switch 805 provided corresponding to the bank 1 is turned ON and supplies the power potential VDD to the cache memory 6 of the bank 1. Then, when the inverter 803 outputs “1”, the transistor switch 805 is turned OFF and stops the supply of the power potential VDD to the cache memory 6 of the bank 1.

When the OR circuit 804 outputs “1”, the transistor switch 806 provided corresponding to the bank 1 is turned ON and supplies the ground potential GND to the cache memory 6 of the bank 1. Then, when the OR circuit 804 outputs “0”, the transistor switch 806 is turned OFF and stops the supply of the ground potential GND to the cache memory 6 of the bank 1.

The power potential VDD and the ground potential GND are always supplied to the cache memory 6 of the bank 0.

By the provision of such a power control circuit 8, a power is supplied to the cache memory 6 selected by the bank control circuit 7 and is not supplied to the cache memory 6 which is not selected. More specifically, when the signal CSIZE indicates “00”, the bank control circuit 7 selects the cache memory 6 of the bank 0. At this time, both of the outputs of the AND circuit 800 and the OR circuit 804 in the power control circuit 8 indicate “0” and each of the outputs of the inverters 801 to 803 indicates “1”. Accordingly, the power potential VDD and the ground potential GND are not supplied to the cache memories 6 of the banks 1 to 7. As a result, the power is supplied to only the cache memory 6 of the bank 0 selected by the bank control circuit 7.

Moreover, when the signal CSIZE indicates “01”, the bank control circuit 7 selects the cache memories 6 of the banks 0 and 1. At this time, both of the outputs of the AND circuit 800 and the inverter 803 in the power control circuit 8 indicate “0” and each of the outputs of the inverters 801 and 802 and the OR circuit 804 indicates “1”. Accordingly, the power potential VDD and the ground potential GND are not supplied to the cache memories 6 of the banks 2 to 7. As a result, a power is supplied to only the cache memories 6 of the banks 0 and 1 selected by the bank control circuit 7.

Furthermore, when the signal CSIZE indicates “10”, the bank control circuit 7 selects the cache memories 6 of the banks 0 to 3. At this time, each of the outputs of the AND circuit 800 and the inverters 802 and 803 in the power control circuit 8 indicates “0” and both of the outputs of the inverter 801 and the OR circuit 804 indicate “1”. Accordingly, the power potential VDD and the ground potential GND are not supplied to the cache memories 6 of the banks 4 to 7. As a result, the power is supplied to only the cache memories 6 of the banks 0 to 3 selected by the bank control circuit 7.

In addition, when the signal CSIZE indicates “11”, the bank control circuit 7 selects all of the cache memories 6. At this time, each of the outputs of the inverters 801 to 803 in the power control circuit 8 indicates “0” and the output of the OR circuit 804 indicates “1”. Accordingly, the power is supplied to all of the cache memories 6 selected by the bank control circuit 7.

Thus, the power control circuit 8 is provided in the cache memory device 10, so that the power is supplied to only the cache memory 6 to be used. Consequently, the power consumption of the cache memory device 10 can be reduced.

While four kinds of cache capacities are implemented at a maximum in the cache memory device 10 shown in FIG. 1, it is possible to implement 2^{m} kinds of cache capacities at a maximum by using an m-bit signal CSIZE (m is an integer) and a (2^{m}−1)-bit signal BID.

In the first embodiment, moreover, the flip-flops 709 to 716 of the bank control circuit 7 are provided for synchronizing the data output of the bank decoder 700 with that of the cache memory 6. In the case in which a data output timing of the cache memory 6 is different from that of the first embodiment, it is also possible to provide a circuit other than the flip-flop to synchronize the data output of the bank decoder 700 with that of the cache memory 6.

In the first embodiment, furthermore, the number of the ways of each of the cache memories 6 (the degree of association) is set to be two (way0, way1). The number of the ways of each of the cache memories 6 may be one or three or more on the assumption that it is equal.

Second Embodiment

FIG. 33 is a flowchart showing a method of designing a cache memory device according to a second embodiment of the present invention. In the second embodiment, there is provided a method of designing the cache memory device 10 according to the first embodiment.

As shown in FIG. 33, first of all, a bank control circuit 7 which can be connected to N1 cache memories 6 and a cache peripheral circuit 5 are designed at a step s1.

A value of N1 is determined depending on a maximum value within a range of a cache capacity to be offered to a user. For example, if a cache capacity of 16K bytes at a maximum is to be offered to the user, the bank control circuit 7 which can be connected to eight cache memories 6 is designed because a data memory 634 of the cache memory 6 has a capacity of 2K bytes.

Then, when the user requires a cache capacity α1 at a step s2, there is designed a cache memory device comprising the bank control circuit 7 and the cache peripheral circuit 5 which are designed in the step s1 and N2 cache memories 6 at a step s3. N2≦N1 is set and a value of N2 is determined depending on the cache capacity α1. For example, if the cache capacity α1 required by the user has 8 K bytes, the value of N2 is set to be “4”.

At the step s3, there is designed the cache memory device 10 comprising the bank control circuit 7 and the cache peripheral circuit 5 which are designed in the step s1. At the step s3, consequently, the bank control circuit 7 and the cache peripheral circuit 5 do not need to be designed newly and N2 cache memories 6 are designed.

Then, a microprocessor 1 comprising the cache memory device 10 designed in the step s3 is designed. Thus, the microprocessor 1 having the cache capacity α1 is offered to the user.

Next, when the cache capacity required by the user is changed and the user requires a cache capacity β1 (≠α1) at a step s4, a cache memory device comprising the bank control circuit 7 and the cache peripheral circuit 5 which are designed in the step s1 and N3 cache memories 6 are designed at a step s5. N3≦N1 and N3≠N2 are set and a value of N3 is determined depending on the cache capacity β1. For example, if the cache capacity β1 required by the user has 4 K bytes, the value of N3 is set to be “2”.

At the step s5, there is designed the cache memory device 10 comprising the bank control circuit 7 and the cache peripheral circuit 5 which are designed in the step s1. At the step s5, consequently, the bank control circuit 7 and the cache peripheral circuit 5 do not need to be designed newly and N3 cache memories 6 are designed.

Then, a microprocessor 1 comprising the cache memory device 10 designed in the step s5 is designed. Thus, the microprocessor 1 having the cache capacity β1 is offered to the user.

In the method of designing the cache memory device according to the second embodiment, thus, the cache memory device 10 comprising the bank control circuit 7 designed previously is designed when the cache capacity is to be changed. When the cache capacity is to be changed, accordingly, it is not necessary to separately design the bank control circuit 7 newly. Accordingly, it is sufficient that a change in the design to be required for varying the cache capacity is lessened.

In the second embodiment, moreover, the cache memory device further comprising the cache peripheral circuit 5 designed previously is designed when the cache capacity is to be changed. When changing the cache capacity, accordingly, it is not necessary to separately design the cache peripheral circuit 5 newly. Therefore, it is possible to further reduce the change in the design to be required for varying the cache capacity.

Third Embodiment

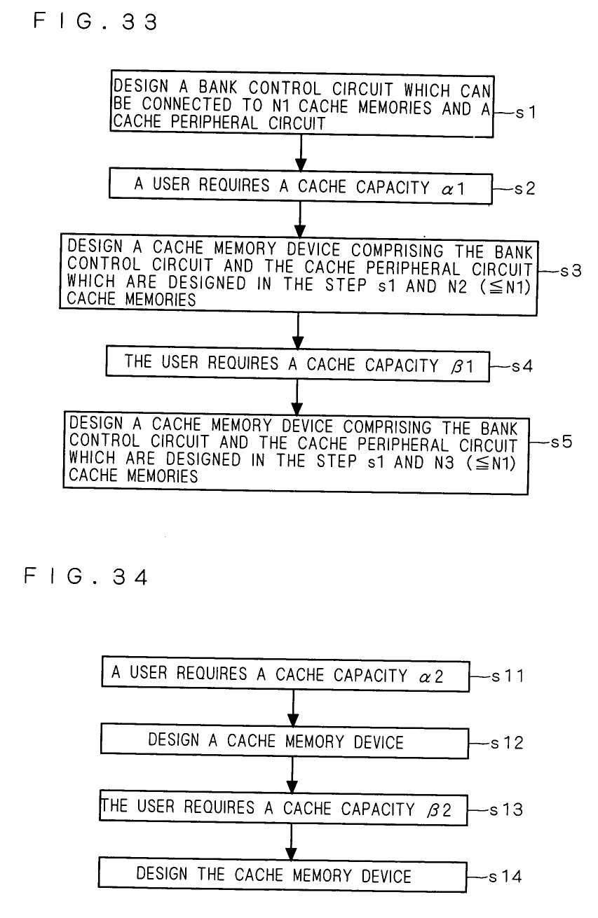

FIG. 34 is a flowchart showing a method of designing a cache memory device according to a third embodiment of the present invention. In the third embodiment, there is provided a method of designing the cache memory device 10 according to the first embodiment which is different from that of the second embodiment.

As shown in FIG. 34, a user requires a cache capacity α2 at a step s11. At a step s12, then, the cache memory device 10 is designed by using a general CAD tool. The step s12 will be described below in detail.

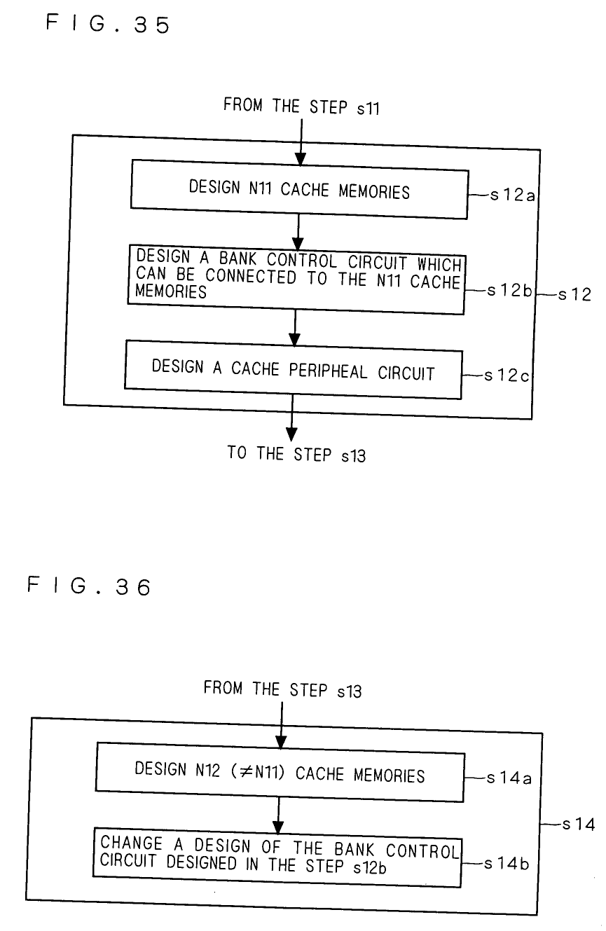

The step s12 is constituted by steps s12a to s12c as shown in FIG. 35. At the step s12a, first of all, N11 cache memories 6 are designed. A value of N11 is determined depending on the cache capacity α2 required by the user. For example, if the cache capacity α2 has 8 K bytes, the value of N11 is set to be “4”.

Next, a bank control circuit 7 which can be connected to the N11 cache memories 6 is designed at the step s12b, and a cache peripheral circuit 5 is designed at the step s12c.

Then, a microprocessor 1 comprising the cache memory device 10 designed in the step s12 is designed. Thus, the microprocessor 1 having the cache capacity α2 is offered to the user.

Next, when the cache capacity required by the user is changed and the user requires a cache capacity β2 (≠α2) at a step s13, the cache memory device 10 is designed by using a general CAD tool at a step s14. The step s14 will be described below in detail.

As shown in FIG. 36, the step s14 is constituted by steps s14a and s14b. First of all, at the step s14a, N12 cache memories 6 are designed. N12≠N11 are set. Moreover, a value of N12 is determined depending on the cache capacity β2 required by the user. For example, if the cache capacity β2 required by the user has 16K bytes, the value of N12 is set to be “8”. Moreover, if the cache capacity β2 has 4K bytes, the value of N12 is set to be “2”.

At the step s14b, then, the bank control circuit 7 designed in the step s12b is redesigned, so that the bank control circuit 7 which can be connected to the N12 cache memories 6 is designed. For example, if N11=4 and N12=8 are set, the design of the bank control circuit 7 shown in FIG. 27 is changed iNT0 the circuit shown in FIG. 5. For example, moreover, if N11=4 and N12=2 are set, the design of the bank control circuit 7 shown in FIG. 27 is changed iNT0 the circuit shown in FIG. 28.

If N12≠N11 is set, thus, the design of the bank control circuit 7 designed in the step s12b is changed into a circuit which can be connected to the N12 cache memories 6.

Moreover, the cache memory device 10 to be designed in the step s14 comprises the cache peripheral circuit 5 designed in the step s12c. Accordingly, it is not necessary to design the cache peripheral circuit 5 at the step s14.

Then, a microprocessor 1 comprising the cache memory device 10 designed in the step s14 is designed. Thus, the microprocessor 1 having the cache capacity β2 is offered to the user.

In the method of designing the cache memory device 10 according to the third embodiment, thus, in the case in which the cache capacity is to be varied, the bank control circuit 7 is redesigned. Therefore, it is not necessary to redesign the cache peripheral circuit 5 as in the third embodiment and to add other circuits. Accordingly, it is possible to reduce a change in the design which is required for varying the cache capacity.

In the third embodiment, moreover, the cache memory device 10 comprising the cache peripheral circuit 5 designed previously is designed when the cache capacity is to be changed. When changing the cache capacity, accordingly, it is not necessary to design the cache peripheral circuit 5. Therefore, it is sufficient that a change in the design to be required for varying the cache capacity is lessened.

In the third embodiment, the bank control circuit 7 is redesigned also in the case in which N12<N11 is set. In this case, the cache memory device 10 comprising the bank control circuit 7 designed in the step s12b is designed at the step s14 so that the bank control circuit 7 does not need to be redesigned at the step s14 as in the designing method according to the second embodiment. In other words, the bank control circuit 7 may be redesigned only when N12>N11 is set.

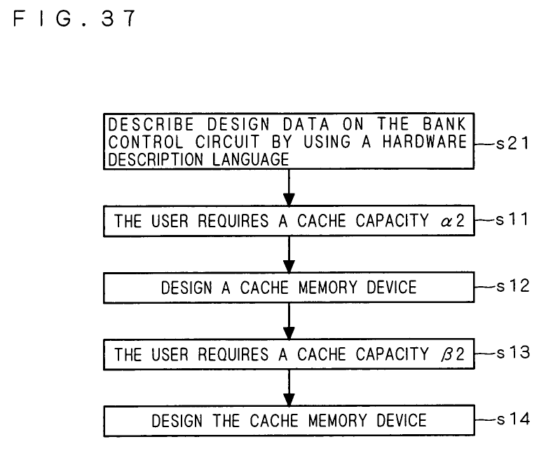

As shown in FIG. 37, moreover, a step s21 may be executed prior to the step s11.

At the step s21, design data about the bank control circuit 7 are previously described by using a hardware descriptive language which employs, as a parameter, a memory capacity corresponding to the total number of the cache memories 6 to which the bank control circuit 7 are connectable.

At the step s12b, next, a memory capacity corresponding to the value of N11 is substituted for the parameter in a logic synthesis to design the bank control circuit 7 which can be connected to the N11 cache memories 6. For example, 8K bytes (=2K bytes×4) are input to the parameter with N11=4.

At the step s14b, then, a memory capacity corresponding to the value of N12 is substituted for the parameter in the logic synthesis to redesign the bank control circuit 7 designed in the step s12b. For example, 16K bytes (=2K bytes×8) are substituted for the parameter with N12=8.

Thus, the design data about the bank control circuit 7 are described by using the hardware descriptive language which employs, as a parameter, the memory capacity corresponding to the total number of the cache memories 6 to which the bank control circuit 7 are connectable.

Fourth Embodiment

FIG. 39 is a flowchart showing a method of designing a microprocessor according to a fourth embodiment of the present invention.

In the first embodiment, also in the case in which only the cache memory 6 of the bank 0 is provided in the microprocessor 1, the cache memory 6 is connected to the bus control circuit 3 and the cache peripheral circuit 5 through the bank control circuit 7 as shown in FIG. 24.

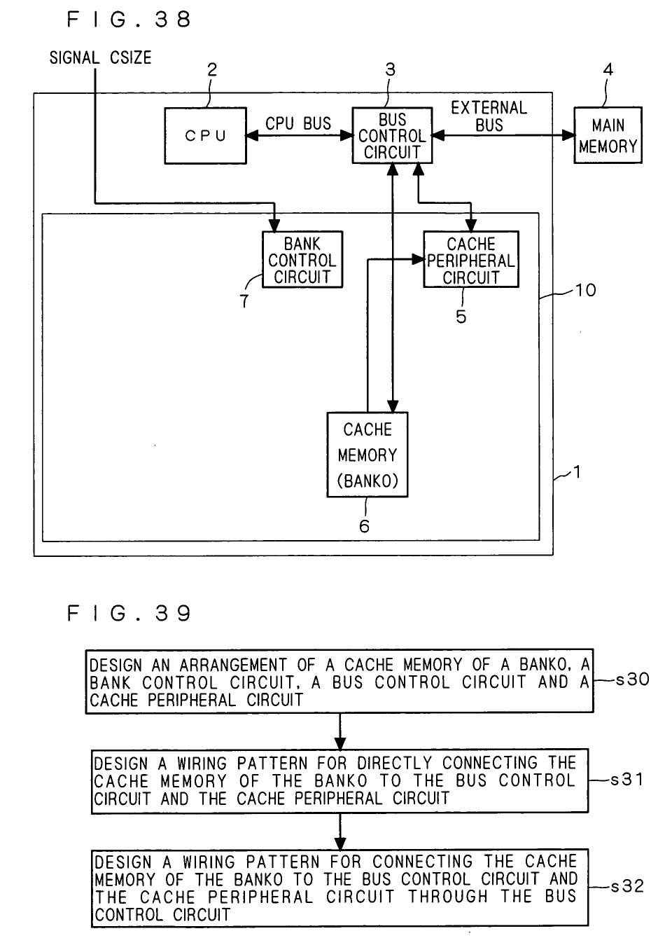

In the case in which only the cache memory 6 of the bank 0 is provided in the microprocessor 1, however, the cache memory 6 of the bank 0 can be directly connected to the bus control circuit 3 and the cache peripheral circuit 5 without using the bank control circuit 7 as shown in FIG. 38. More specifically, the microprocessor 1 shown in FIG. 38 can be obtained in the following manner.

In the microprocessor 1 shown in FIG. 24, an output terminal for outputting the bank 0 read data B0RD of the cache memory 6 of the bank 0 is directly connected to an input terminal for inputting the memory read data MRD of the cache peripheral circuit 5, and an output terminal for outputting the cache memory control signal CMCNT of the bus control circuit 3 is directly connected to an input terminal for inputting the bank 0 control signal B0CNT of the cache memory 6 of the bank 0. Moreover, an output terminal for outputting the bank 0 status read data B0SRD of the cache memory 6 of the bank 0 is directly connected to an input terminal for inputting the status read data SRD of the bus control circuit 3.

Also in the case in which the cache memory 6 is to be directly connected to the bus control circuit 3 and the cache peripheral circuit 5, the bank control circuit 7 is provided in the cache memory device 10 as shown in FIG. 38 in order to simplify addition of the cache memory 6.

By directly connecting the cache memory 6 of the bank 0 to the bus control circuit 3 and the cache peripheral circuit 5 without using the bank control circuit 7, thus, it is also possible to implement a cache capacity of 2 K bytes. In the case in which the cache memory 6 of the bank 0 is directly connected to the bus control circuit 3 and the cache peripheral circuit 5, the cache memory 6 of the bank 0 can be accessed at a higher speed.

In the method of designing a microprocessor according to the fourth embodiment, first of all, an arrangement of the cache memory 6 of the bank 0, the bank control circuit 7, the cache peripheral circuit 5 and the bus control circuit 3 is designed by using a general CAD tool at a step s30 as shown in FIG. 39.

At a step s31, next, a first wiring pattern for directly connecting the cache memory 6 of the bank 0 to the bus control circuit 3 and the cache peripheral circuit 5 is designed in the arrangement designed in the step s30. At a step s32, then, a second wiring pattern for connecting the cache memory 6 of the bank 0 to the bus control circuit 3 and the cache peripheral circuit 5 through the bank control circuit 7 is designed in the arrangement designed in the step s30.

By designing the first and second wiring patterns, thus, it is possible to easily design the microprocessor 1 in which the cache memory 6 of the bank 0 is directly connected to the bus control circuit 3 and the cache peripheral circuit 5, and the microprocessor 1 in which the cache memory 6 of the bank 0 is connected to the bus control circuit 3 and the cache peripheral circuit 5 through the bank control circuit 7.

When the microprocessor 1 comprising only the cache memory 6 of the bank 0 is to be designed, accordingly, the first wiring pattern designed in the step s31 is used. When the microprocessor 1 comprising a plurality of cache memories 6 is to be designed, the second wiring pattern designed in the step s32 is used. Consequently, it is possible to lessen a change in the design when varying a cache capacity.

In the case in which one cache memory 6 is provided, the cache memory 6 can be accessed without using the bank control circuit 7. Therefore, the cache memory 6 can be accessed at a high speed.

By fabricating a first wiring mask from the first wiring pattern and fabricating a second wiring mask from the second wiring pattern to simply change a wiring mask to be used, moreover, it is possible to directly connect the cache memory 6 of the bank 0 to the bus control circuit 3 and the cache peripheral circuit 5 or to connect the cache memory 6 of the bank 0 to the bus control circuit 3 and the cache peripheral circuit 5 through the bank control circuit 7.

While the invention has been shown and described in detail, the foregoing description is in all aspects illustrative and not restrictive. It is therefore understood that numerous modifications and variations can be devised without departing from the scope of the invention.

What is claimed is:

1. A cache memory device comprising:
at least one cache memory storing copy data of a main memory, and
a bank control circuit, connected to said at least one cache memory, and capable of generating a plurality of control signals for access, said bank control circuit receiving a signal indicative of cache capacity and permitting at least one control signal selected out of said plurality of control signals to access said at least one cache memory, respectively, in accordance with said signal.

2. The cache memory device according to claim 1, wherein said bank control circuit controls access to said at least one cache memory in such a manner that one accessing operation implements access to only one out of said at least one cache memory.

3. The cache memory device according to claim 1, wherein said at least one cache memory has a plurality of cache memories, said cache memory device further comprising a power control circuit for controlling power supply to said plurality of cache memories connected to said bank control circuit based on said signal,
said power control circuit supplying a power to only one or more cache memories accessed with said at least one control signal selected by said bank control circuit out of said plurality of cache memories.

4. The cache memory device according to claim 1, wherein a cache address indicating an address of said main memory and including a tag and an index is input to said cache memory device,
a bit position occupied by said tag and said index is fixed in said cache address,
said at least one cache memory has a tag memory setting said index in said cache address to be an address, and
said tag memory stores said tag in said cache address,
said cache memory device further comprising:
a cache peripheral circuit for linking said index in said cache address input to said cache memory device when one or more cache memories accessed with said at least one control signal selected by said bank control circuit is accessed, to data in said tag memory stored in said address indicated by said index, and for generating and outputting a copy back address,
a copy back method using said copy back address being employed as a writing method for said main memory.

5. The cache memory device according to claim 1, wherein a cache address indicating an address of said main memory and including a tag and an index is input to said cache memory device,
a bit position occupied by said tag and said index is fixed in said cache address,
said at least one cache memory has a tag memory setting said index in said cache address to be an address, and
said tag memory stores said tag in said cache address,
said cache memory device further comprising:
a comparator for comparing said tag in said cache address input to said cache memory device when one or more cache memories accessed with said at least one control signal selected by said bank control circuit is accessed, to data in said tag memory stored in said address indicated by said index in said cache address, and for detecting their coincidence/non-coincidence.

6. The cache memory device according to claim 1, wherein said at least one cache memory has a plurality of cache memories,
a cache address indicating an address of said main memory and including a tag is input to said cache memory device,
a bit position occupied by said tag is fixed in said cache address,
said plurality of cache memories have respective tag memories for storing said tag in said cache address, and
said respective tag memories store plural pieces of fixed data peculiar to said plurality of cache memories, respectively, each of said plural pieces of fixed data corresponding to a part of said tag.

7. The cache memory device according to claim 1, wherein said at least one cache memory has a plurality of cache memories, and
said plurality of cache memories have the same memory capacity.

8. A method of designing a cache memory device comprising at least one cache memory for storing copy data of a main memory, wherein said method comprises the steps of;
(a) designing a bank control circuit connectable to a first predetermined number of plural cache memories, and capable of permitting one or more cache memories of the first predetermined number of plural cache memories to be accessed, and changing the number of said one or more cache memories to be permitted to be accessed;
(b) designing a first cache memory device including said bank control circuit designed in said step (a); and
(c) designing a second cache memory device including said bank control circuit designed in said step (a);
said step (b) including the step of:
(b-1) designing a second predetermined number of cache memories which is equal to or smaller than said first predetermined number, and
said step (c) including the step of:
(c-1) designing a third predetermined number of cache memories which is equal to or smaller than said first predetermined number and is different from said second predetermined number.

9. The method of designing a cache memory device according to claim 8, wherein said cache memory device receives a cache address indicating an address of said main memory and including a tag and an index,
wherein a bit position occupied by said tag and said index is fixed in said cache address,
said at least one cache memory has a tag memory setting said index in said cache address to be an address, and
said tag memory stores said tag in said cache address,
said method further comprising the step of:
(d) designing a cache peripheral circuit linking said index in said cache address received by said cache memory device when said at least one cache memory is accessed, to data in said tag memory stored in said address indicated by said index, and generates and outputs a copy back address, wherein
a copy back method using said copy back address is employed as a writing method for said main memory, and
said first and second cache memory devices further comprising said cache peripheral circuit designed in said step (d) are designed at said steps (b) and (c), respectively.

10. The method of designing a cache memory device according to claim 8, wherein said cache memory device receives a cache address indicating an address of said main memory and including a tag and an index,
a bit position occupied by said tag and said index is fixed in said cache address,
said at least one cache memory has a tag memory setting said index in said cache address to be an address,
said tag memory stores said tag in said cache address,
said method comprising the step of:
(e) designing a comparator comparing said tag in said cache address received by said cache memory device when said at least one cache memory is accessed, to data in said tag memory stored in said address indicated by said index in said cache address, and detects their coincidence/non-coincidence, wherein
said first and second cache memory devices further comprising said comparator designed in said step (e) are designed at said steps (b) and (c), respectively.

11. A method of designing a cache memory device comprising at least one cache memory for storing copy data of a main memory;
said method comprising the steps of:
(a) designing a first cache memory device; and
(b) designing a second cache memory device after said step (a),
said step (a) including the step of:
(a-1) designing a bank control circuit connectable to a first predetermined number of plural cache memories, and capable of permitting one or more cache memories of the first predetermined number of plural cache memories to be accessed and changing the number of said one or more cache memories to be permitting to be accessed, and
said step (b) including the steps of:
(b-1) designing a second predetermined number of cache memories; and
(b-2) redesigning said bank control circuit designed in said step (a) in such a manner that said second predetermined number of cache memories are connected when said second predetermined number is greater than said first predetermined number.

12. The method of designing a cache memory device according to claim 11, further comprising the step of:
(c) describing design data about said bank control circuit by using a hardware descriptive language which employs, as a parameter, a memory capacity corresponding to a total number of the first predetermined number of plural cache memories, prior to said step (b),
at said step (b-2), a memory capacity corresponding to said second predetermined number being substituted for said parameter, thereby redesigning said bank control circuit designed in said step (a).

13. The method of designing a cache memory device according to claim 11, wherein said cache memory device receives a cache address indicating an address of said main memory and including a tag and an index,
a bit position occupied by said tag and said index is fixed in said cache address,
said at least one cache memory has a tag memory setting said index in said cache address to be an address, and
said tag memory stores said tag in said cache address,
said method of designing further comprising the step of:
(d) designing a cache peripheral circuit linking said index in said cache address received by said cache memory device when said at least one cache memory is accessed, to data in said tag memory stored in said address indicated by said index, and generating and outputting a copy back address, wherein
a copy back method using said copy back address is employed as a writing method for said main memory,
at said step (a), said first cache memory device includes said cache peripheral circuit designed at step (d), and
at said step (b), said second cache memory device further comprising said cache peripheral circuit designed in said step (d) is designed.

14. The method of designing a cache memory device according to claim 11, wherein said cache memory device receives a cache address indicating an address of said main memory and including a tag and an index,
a bit position occupied by said tag and said index is fixed in said cache address,
said at least one cache memory has a tag memory setting said index in said cache address to be an address, and
said tag memory stores said tag in said cache address,
said method of designing further comprising the step of:
(e) designing a comparator comparing said tag in said cache address received by said cache memory device when said at least one cache memory is accessed, to data in said tag memory stored in an address indicated by said index in said cache address, and detecting their coincidence/non-coincidence, wherein
at said step (b), said second cache memory device further comprising said comparator designed in said step (e) is designed.

15. A bank control circuit controlling an access to a cache memory, comprising;
a decoder receiving first and second signals and outputting bank select signals such that one of the bank select signals is active in accordance with said first and second signals, wherein said first signal is indicative of a cache capacity used in the cache memory and said second signal is a part of an address supplied to the cache memory, and
signal output circuits provided correspondingly to the bank select signals, respectively, each signal output circuit receiving a control signal for accessing the cache memory and a corresponding bank select signal, and permitting the control signal to be output to the cache memory in response to an active state of said corresponding bank control signal while inhibiting said control signal to be output to the cache memory in response to a non-active state of said corresponding bank control signal.
